(19) United States
(12) Patent Application Publication
(10) Pub. No.: US 2026/0120464 A1
(43) Pub. Date: Apr. 30, 2026

(54) IMAGE DISPLAY METHOD, IMAGE DATA PROCESSING METHOD, AND DEVICE

(71) Applicant: LUMI UNITED TECHNOLOGY CO., LTD., Shenzhen City (CN)

(72) Inventors: PANPAN XU, Shenzhen City (CN); MENGTING HUANG, Shenzhen City (CN); JUAN SONG, Shenzhen City (CN); RUIHAO GAO, Shenzhen City (CN); TINGTENG ZHAO, Shenzhen City (CN)

(73) Assignee: LUMI UNITED TECHNOLOGY CO., LTD., Shenzhen City (CN)

(21) Appl. No.: 19/433,696

(22) Filed: Dec. 26, 2025

Related U.S. Application Data
(63) Continuation-in-part of application No. PCT/CN2023/102882, filed on Jun. 27, 2023.

(30) Foreign Application Priority Data
Feb. 26, 2025 (CN) 202510217069.8
Apr. 18, 2025 (CN) 202510493350.4

(51) Int. Cl. G06V 20/40

(52) U.S. Cl. CPC G06V 20/44; G06V 20/46

(57) ABSTRACT

The present disclosure relates to an image display method, an image data processing method, and a device. The method includes: displaying an event entry area, which includes event thumbnails corresponding to each event; the event thumbnails are generated based on images related to each event identified from the collected image data; in response to a viewing operation on a selected target event thumbnail, displaying an image display page, and displaying the target event view corresponding to the event of the target event thumbnail on the image display page.

The present disclosure is a continuation in part of PCT international patent application No. PCT/CN2023/102882 filed on Jun. 27, 2023, and claims priorities to the Chinese patent application No. CN202510217069.8 filed on Feb. 26, 2025, and Chinese patent application No. CN202510493350.4 filed on Apr. 18, 2025. The entire contents of the aforementioned applications are incorporated herein by reference.

### TECHNICAL FIELD

The present disclosure relates to the technical field of electronic devices, and in particular, the present disclosure relates to an image display method, an image data processing method, and a device.

### BACKGROUND

With the development of Internet of Things (IoT) technology and the increasing awareness of security among people, more and more video surveillance devices are being applied in people's production and daily life. These video surveillance devices are capable of recording surveillance videos of specific areas, thereby enabling people to determine whether there are any abnormalities or safety hazards by reviewing the surveillance videos.

However, in practice, video surveillance devices usually record continuously for long periods of time, resulting in surveillance videos of considerable length. But people are often only interested in certain events within the entire video. Nevertheless, long-duration videos are not convenient for people to review the corresponding events.

### SUMMARY OF THE DISCLOSURE

The present disclosure relates to an image display method, an image data processing method, and a device.

First Aspect: the embodiments of this present disclosure provide an image display method, performed by a user terminal, the method includes: displaying an event entry area, wherein the event entry area includes event thumbnails corresponding to each event; the event thumbnails are generated based on images related to each event identified from the collected image data; in response to a viewing operation on a selected target event thumbnail, displaying an image display page, and displaying the target event view corresponding to the event of the target event thumbnail on the image display page.

Second Aspect: the embodiments of this present disclosure provide an image data processing method, performed by an electronic device, the method includes: recognizing events in the collected image data to obtain event images corresponding to each event; extracting images corresponding to each of the events from the event images corresponding to each event, and generating event thumbnails corresponding to each of the events based on the images; the event thumbnails are used for indexing and display in the event entry area, and for displaying the target event view corresponding to the event of the event thumbnail in response to a viewing operation on the event thumbnail in the event entry area.

Third Aspect: the embodiments of this present disclosure also provide an electronic device, includes at least one processor and at least one memory, the memory storing computer-readable instructions, wherein when the computer-readable instructions are executed by the processor, they implement the steps of the image display method described in the first aspect, or implement the steps of the image data processing method described in the second aspect.

### BRIEF DESCRIPTION OF THE DRAWINGS

To more clearly illustrate the technical solutions in the embodiments of the present disclosure, a brief introduction to the drawings required in the following description of the embodiments will be provided. It is evident that the drawings described below are merely some embodiments of the present disclosure, and for those skilled in the art, other drawings may be obtained based on these drawings without the need for creative labor.

FIG. 1 is a diagram of the implementation environment of the image display method and the image data processing method in an embodiment.

FIG. 2 is a flowchart of the image display method in an embodiment.

FIG. 3 is a flowchart of the image data processing method in an embodiment.

FIG. 4 is a flowchart of the image display method and the image data processing method in an embodiment.

FIG. 5 is a schematic diagram of the home page of a present disclosure in an embodiment.

FIG. 6 is a schematic diagram of the event configuration page of a present disclosure in an embodiment.

FIG. 7 is another schematic diagram of the home page of a present disclosure in an embodiment.

FIG. 8 is a schematic diagram of the camera album page of a present disclosure in an embodiment.

FIG. 9 is another schematic diagram of the camera album page of a present disclosure in an embodiment.

FIG. 10 is a schematic diagram of an intermediate page of a present disclosure in an embodiment.

FIG. 11 is a schematic diagram of the album page of a present disclosure in an embodiment.

FIG. 12 is a schematic diagram of a present disclosure displaying an enlarged image in an embodiment.

FIG. 13 is another schematic diagram of the album page of a present disclosure in an embodiment.

FIG. 14 is a schematic diagram of a playback page in an embodiment.

FIG. 15 is a flowchart of an image processing method provided by the embodiments of this present disclosure.

FIG. 16 is a schematic diagram of a display interface provided by the embodiments of this present disclosure.

FIG. 17 is a schematic diagram of the operation interface corresponding to the real-time mode button provided by the embodiments of this present disclosure.

FIG. 18 is a schematic diagram of the operation interface corresponding to the playback mode button provided by the embodiments of this present disclosure.

FIG. 19A is a schematic diagram of a trigger adjustment operation provided by the embodiments of this present disclosure.

FIG. 19B is another schematic diagram of a trigger adjustment operation provided by the embodiments of this present disclosure.

FIG. 20 is a flowchart of judging whether the area ratio of the image display area meets the adjustment condition provided by the embodiments of this present disclosure.

FIG. 21A is a schematic diagram of performing a first adjustment operation provided by the embodiments of this present disclosure.

FIG. 21B is another schematic diagram of performing a first adjustment operation provided by the embodiments of this present disclosure.

FIG. 22 is a schematic diagram of performing a first return operation provided by the embodiments of this present disclosure.

FIG. 23 is another flowchart of an image processing method provided by the embodiments of this present disclosure.

FIG. 24 is a flowchart of an information display method in an embodiment.

FIG. 25 is a schematic diagram of a timeline in an embodiment.

FIG. 26 is a schematic diagram of an information display page in an embodiment.

FIG. 27 is a schematic diagram of an information display page in another embodiment.

FIG. 28 is a schematic diagram of operating a timeline in an embodiment.

FIG. 29 is a schematic diagram of an event identifier in an embodiment.

FIG. 30 is a schematic diagram of a timeline in another embodiment.

FIG. 31 is a schematic diagram of a timeline in yet another embodiment.

FIG. 32 is a flowchart of drawing a timeline in an embodiment.

FIG. 33 is a schematic diagram of drawing a timeline in an embodiment.

FIG. 34 is a structural block diagram of an image display device in an embodiment.

FIG. 35 is a structural block diagram of an image data processing device in an embodiment.

FIG. 36 is a structural schematic diagram of an image processing device provided by the embodiments of this present disclosure.

FIG. 37 is a structural block diagram of an information display device in an embodiment.

FIG. 38 is a structural schematic diagram of an electronic device in an embodiment.

### DETAILED DESCRIPTION

In order to make the objectives, technical solutions, and advantages of this present disclosure clearer and more understandable, the following is a further detailed description of this present disclosure in conjunction with the accompanying drawings and embodiments. It should be understood that the specific embodiments described here are merely configured to explain this present disclosure and are not intended to limit this present disclosure.

### The Present Disclosure Overview

As described in the background technology section, with the development of the Internet of Things (IoT), the use of video surveillance devices is becoming increasingly common in people's production and daily life. Video surveillance devices may transmit the captured video images to the IoT platform, and then users may access the IoT platform via terminal devices such as mobile phones and computers to view the captured video images at any time. In addition, the captured video images may also be stored as video files for users to view at any time according to their own needs later.

To facilitate understanding, an example is provided here. For instance, the video surveillance device is a smart camera installed in a user's home and connected to the IoT platform. After the smart camera is activated, it transmits the captured video images of the home in real-time to the IoT platform. Users may access the IoT platform through their mobile phones to view what is happening at home at any time. Meanwhile, the video images captured by the smart camera may also be stored as video files. In this way, even if users miss something, they may view the missed events at any time through the stored video files. Under normal circumstances, to avoid omissions, the smart camera will continuously record after being activated, thereby recording all events during the recording period and ultimately generating a long video file.

In the above technology, in some scenarios, users need to view the video images corresponding to a specific event or certain events. At this time, users may only slowly scroll through the timeline of the video file to find the corresponding video images. The entire process is relatively cumbersome, and it is not convenient for users to operate, often being time-consuming and labor-intensive.

In response to the above issues, this present disclosure provides an image display method, an image data processing method, and a device, with the aim of quickly presenting the video images corresponding to the events being queried by users and effectively reducing the number of user operations. The specific solutions will be detailed below through embodiments.

### Exemplary Implementation Environment

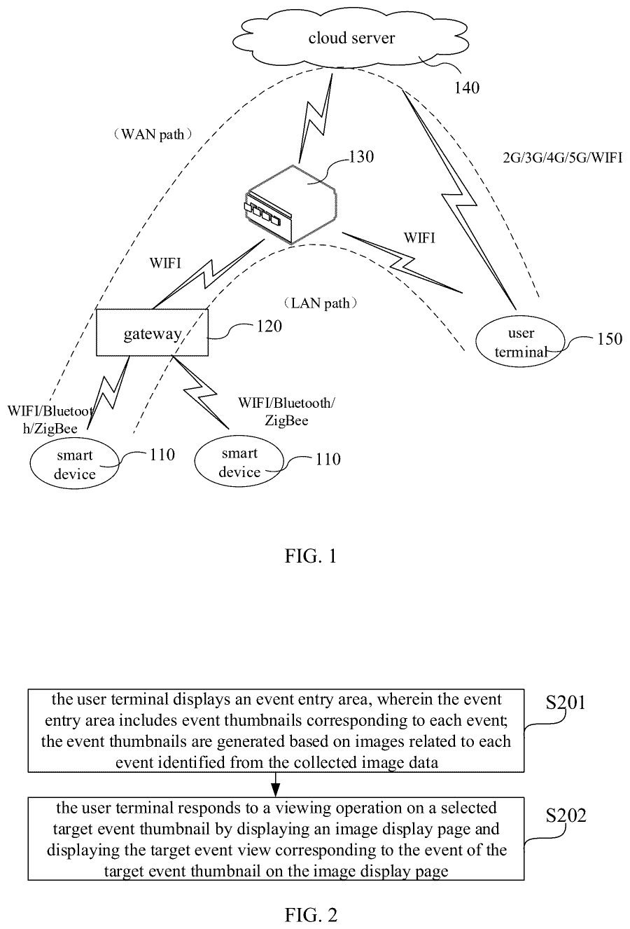

The image display method and image data processing method provided by this disclosure may be applied to the implementation environment shown in FIG. 1. This implementation environment may be an Internet of Things (IoT) platform, where one or more smart devices 110 may be connected to a gateway 120 via WIFI, Bluetooth, ZIGBEE (ZigBee), and other methods. The gateway 120 is connected to a router 130 via WIFI, and the router 130 is connected to a cloud server 140 via WIFI. In addition, in some scenarios, the router 130 is also connected to a user terminal 150 via WIFI, and the user terminal 150 is connected to the cloud server 140 via 2G/3G/4G/5G/WIFI and other methods. It should be understood, of course, that the communication connections between the above devices are not limited to the connection methods listed above and may be adjusted accordingly based on actual needs. After the above devices are interconnected, they may achieve a communication process, which includes but is not limited to data interaction and command transmission.

Smart devices 110 may include, but are not limited to, smart curtain motors, smart door locks, smart printers, smart fax machines, smart cameras, smart air conditioners, smart TVs, smart refrigerators, or human body sensors, door and window sensors, temperature and humidity sensors, water leakage sensors, natural gas alarms, smoke alarms, wall switches, wall sockets, wireless switches, wireless wall sticker switches, magic cube controllers, and other devices equipped with communication modules (such as ZIGBEE modules, WIFI modules, Bluetooth communication modules, etc.), without limitation. The gateway 120 may be a network interconnection device with central capabilities or a camera device with gateway functions.

Among them, the user terminal 150 may be a smartphone, laptop, personal computer, tablet, smart control panel, or other electronic devices that may implement network connections, without limitation. The cloud server 140 may be implemented using an independent server or a server cluster composed of multiple servers.

Specifically, smart devices 110 with camera functions or gateways 120 may capture image data within the corresponding range. Then, the captured image data may be processed by the device, server, or user terminal to recognize events and obtain event images corresponding to each event. Images corresponding to each event are extracted from the event images, and event thumbnails corresponding to each event are generated based on these images. The event thumbnails are used for indexing and display in the event entry area of the user terminal interface. By responding to viewing operations on the event thumbnails in the event entry area, users may quickly view the target event images corresponding to the selected event thumbnails without having to watch the entire video. This effectively reduces the number of user operations, thereby improving the user experience and increasing the viewing rate of video images.

It may be understood that the above implementation environment is not the only environment for implementing the image display method and image data processing method provided by this disclosure, but one of the environments that may implement the methods provided by this disclosure. Here, only the IoT platform is used as an example to illustrate the image display method and image data processing method provided by this disclosure.

The image processing method provided by this disclosure may be applied to the implementation environment shown in FIG. 1. The user terminal 150 may have an application (Application, APP) installed on it. This application includes an add interface, where users may add at least one gateway. They may also add sub-devices such as sensors, switches, and cameras through the add sub-device button on this interface. Then, users may select the gateway that the sub-device needs to connect to on the add interface. This allows the sub-device to be added to the ZIGBEE network corresponding to the gateway, forming a ZIGBEE local area network together with other added sub-devices and the gateway. When the APP is in the same local area network as the router and gateway, the APP may interact with the gateway and the sub-devices connected to it through the local network path. When the APP is not in the same local area network as the router and gateway, it interacts with the gateway and the connected sub-devices through the wide area network path.

The sub-devices in this space, such as sensors, switches, and cameras, may capture the images or videos of the corresponding space in real time and send the captured images or videos to the user terminal.

The user terminal may display an image display area on the display interface of the application. This image display area is configured to display the images captured by the camera device (that is, the capture device, such as a camera). Users may trigger an adjustment operation on the image display area on this display interface. The user terminal may respond to the adjustment operation on the image display area. It may determine whether the area ratio of the image display area meets the adjustment condition. If the area ratio meets the adjustment condition, the user terminal adjusts the area ratio of the image display area while keeping the display ratio of the image unchanged. The area ratio is configured to indicate the proportion of the image display area in the display interface. The display ratio of the image is configured to indicate the display ratio of the image itself.

The information display method provided by the embodiments of this disclosure may be applied to the implementation environment shown in FIG. 1, which may be a smart home system. As shown in FIG. 1, the smart home system may include smart devices with monitoring functions for target objects such as humans, animals, plants, etc., such as cameras, radars, smart door locks, door and window sensors, smart lights, etc. Among them, the camera device may be a camera or a smart device with a camera function, and the associated devices related to the camera device may include smart devices such as smart door locks, door and window sensors, smart lights, etc.

In current technologies, the timeline on the information display page of the camera device has a low efficiency in displaying event information, requiring users to perform multiple operations to view the corresponding events. For example, if a user wants to check an event on the timeline, they need to swipe through a long segment of the timeline to locate the event, and it is also easy to miss the event they want to check due to swiping too quickly.

In response to this, the method provided by this disclosure may display a timeline corresponding to the monitoring data obtained by at least one of the camera device and the associated devices on the information display page. It may display the event information corresponding to the target event on the timeline in the target style according to at least one of the event time and event type of the target event obtained by recognizing the monitoring data (which may specifically include event identifiers and event label information, etc.). Users may view the information of the target event on the timeline without multiple operations, thereby improving the efficiency of the timeline on the information display page in displaying event information.

### Exemplary Method

Please refer to FIG. 2. In an exemplary embodiment, an image display method is provided, which is illustrated by being applied to a user terminal. The user terminal may specifically be the user terminal 150 shown in FIG. 1. Among them, at least one smart device 110 in the implementation environment shown in FIG. 1 may capture and generate video files, and store the video files in at least one of the gateway 120 and the cloud server 140. The user terminal 150 may access the video file through at least one of the gateway 120 and the cloud server 140.

The image display method may be executed by the above-mentioned user terminal. As shown in FIG. 2, the method may include the following steps:
Step S201: the user terminal displays an event entry area, wherein the event entry area includes event thumbnails corresponding to each event; the event thumbnails are generated based on images related to each event identified from the collected image data.

An event may be a matter that occurs in a preset situation. The event entry area is the entire or part of the current display interface of the user terminal. This event entry area may display data such as images, Chinese characters, letters, numbers, and special symbols. Suppose there is an application provided by the Internet of Things platform installed on the user terminal. In that case, the event entry area may be a part of any page of that application. For example, the event entry area may be a predetermined area of at least one of the home page and the camera album page of the application. When the user terminal displays the home page or the camera album page of the application, the event thumbnails corresponding to each event are displayed through the predetermined area of the home page or the camera album page.

It may be understood that an event thumbnail may be a diagram that reflects the state of an event occurring at a particular moment through an image. Specifically, it may be an image that better describes the occurrence of a preset event detected at a particular moment among multiple frames of image data, which serves as the event thumbnail corresponding to that event.

Based on this, since the event thumbnail is generated from images related to each event identified from the collected image data, the content of the event thumbnail is associated with the event corresponding to the event thumbnail. In some embodiments, the event corresponding to the event thumbnail may be an event that the content of the event thumbnail represents has occurred or is occurring. For example, if the content of an event thumbnail is an open window, the event corresponding to that event thumbnail may be a window-opening event.

It may be understood that users may easily know which event corresponds to the event thumbnail through the event thumbnail in the event entry area. Therefore, displaying the event thumbnails corresponding to each event in the event entry area may facilitate users in choosing the events they are interested in for subsequent operations according to their own needs.

In addition, the number of event thumbnails in the event entry area is not limited to one. In some embodiments, if there are multiple event thumbnails, the event thumbnails are displayed dynamically within the event entry area.

Specifically, when the event entry area includes multiple event thumbnails, each event thumbnail corresponds to an event. Moreover, the content of different event thumbnails may be the same or different, and the events corresponding to different event thumbnails may also be the same or different. In some scenarios, the events corresponding to multiple event thumbnails are not entirely the same, or even completely different. Since different users may be interested in different events, and even the same user may be interested in different events under different circumstances, users may operate any event thumbnail. To avoid affecting the use of some users due to the failure to display a particular or some event thumbnails.

In this embodiment, the user terminal will display each event thumbnail in the event entry area separately, dynamically displaying each event thumbnail to the user in turn. By displaying multiple event thumbnails in the event entry area, it may avoid the situation where the failure to display a particular or some event thumbnails affects the normal use of some users. Furthermore, compared with displaying all event thumbnails simultaneously, this embodiment adopts a dynamic display method to display each event thumbnail in turn, allowing the event thumbnails to occupy a smaller area on the image display page. At the same time, it breaks through the limitation of the area of the image display page on the number of event thumbnails, enabling a larger number of event thumbnails to be displayed on the image display page.

In some embodiments, when dynamically displaying the event thumbnails on the user terminal, the event thumbnails may be cyclically displayed in the event entry area of the user terminal. Each event thumbnail will be displayed once within each cycle. The cycle duration may be a relatively short period of time.

Specifically, in one embodiment, the cycle duration may be a relatively short fixed period, regardless of the number of event thumbnails. The display will cycle through the images according to this fixed cycle duration. For example, the cycle duration could be 5 seconds, but it is not limited to this. In another embodiment, the display interval between adjacent event thumbnails may be a relatively short fixed period, and the cycle duration may vary depending on the number of event thumbnails. Suppose the display interval between adjacent event thumbnails are 1 second. If there are 4 event thumbnails, then the cycle duration would be 3 seconds. If there are 5 event thumbnails, then the cycle duration would be 4 seconds. It should be understood that the display interval between adjacent event thumbnails is not limited to 1 second and may be set according to actual needs.

In some embodiments, the user terminal may also dynamically display the event thumbnails based on user operations in the event entry area. In other words, users may manually switch between the display of different event thumbnails. For example, the event thumbnails may be displayed in the form of a carousel. Users may swipe the currently displayed event thumbnail in the event entry area to display other event thumbnails.
Step S202: the user terminal responds to a viewing operation on a selected target event thumbnail by displaying an image display page and displaying the target event view corresponding to the event of the target event thumbnail on the image display page.

The target event thumbnail is the event thumbnail selected in the event entry area. Specifically, when the event entry area includes multiple event thumbnails, the target event thumbnail may be any one of these images. This means that users may freely choose the target event thumbnail on the user terminal according to their own needs. The viewing operation may be a click, swipe, long press, etc., but is not limited to these. The user terminal responds when it receives a viewing operation and displays the image display page. The image display page is a page that may display image content, such as pictures, videos, etc. Continuing with the example of a user terminal installed with an application provided by an Internet of Things platform, the image display page may be any page of the application. For example, the image display page may be the camera playback page of the application, but it is not limited to this.

Additionally, the target event view is the event image corresponding to the target event, and the target event is the event corresponding to the target event thumbnail. In this way, when users focus on the target event, by selecting and performing a viewing operation on the target event thumbnail corresponding to the target event, they may see the event image corresponding to the target event on the user terminal. Therefore, the image displayed on the image display page should match the event thumbnail that the viewing operation is targeted at. For example, if the target event is a window-opening event and the target event thumbnail is an image of an open window, the corresponding target event view may be at least one frame from the process of the window being opened.

In some embodiments, the event image is an image related to the event from the image data collected in the aforementioned step S201. Correspondingly, the target event view is an image related to the target event from the image data collected in step S201. In this way, when users focus on the target event, by selecting and performing a viewing operation on the target event thumbnail, the user terminal may directly locate the image related to the target event in the image data collected in step S201 and display it.

In some embodiments, displaying the target event view corresponding to the event of the target event thumbnail on the image display page in step S202 includes: the user terminal displaying at least one of an enlarged image and a video clip corresponding to the target event thumbnail on the image display page.

Specifically, each event thumbnail corresponds to at least one of an enlarged image with the same image content and a video clip that records the event corresponding to the event thumbnail. Compared to the event thumbnail, the enlarged image has a larger size. In some embodiments, at least one of the resolution and clarity of the enlarged image is also higher than that of the event thumbnail. The video clip corresponding to the target event thumbnail records the target event. In some embodiments, the video clip that records the target event is a video clip composed of images related to the target event from the image data collected in the aforementioned step S201.

In one embodiment, a single video file records the events corresponding to each event thumbnail, so that the video clips corresponding to each event thumbnail are different segments of the same video file. In this way, the number of video files may be reduced. In another embodiment, different video files record the events corresponding to different event thumbnails, with each video file serving as a video clip. Although this increases the number of video files, the video files may be distinguished by the events they record, making them easier to manage. For example, ten video files record ten different events. When users no longer focus on several of these events, they may delete the video files that record these events and retain only the video files that record the events they might still be interested in.

It may be understood that enlarged images and video clips may meet users'needs at different levels. In some scenarios, users only need to view the enlarged image to meet their needs. In this case, only the enlarged image needs to be provided to the user. In other scenarios, because the enlarged image provides limited information and cannot meet users'needs, the user terminal needs to provide the video clip to the user to satisfy their deeper needs. This embodiment uses at least one of the enlarged image corresponding to the target event thumbnail and the video clip corresponding to the target event thumbnail as the target event view displayed on the image display page. This way, the image content may be provided to users with a better visual experience by displaying the enlarged image. The user terminal may also provide more information related to the event to the user by displaying the video clip. It may even display both the enlarged image and the video clip simultaneously, providing users with a better visual experience of the image content while also offering more information related to the event. By flexibly selecting which data content to display on the image display page between the enlarged image and the video clip, the user's needs for the event at different levels may be met.

In some embodiments, the target event view displayed on the image display page of the user terminal varies depending on the viewing operation performed on the target event thumbnail. For example, if the viewing operation on the target event thumbnail is a first viewing operation, the target event view displayed on the image display page of the user terminal is the enlarged image corresponding to the target event thumbnail. If the viewing operation on the target event thumbnail is a second viewing operation, the target event view displayed on the image display page of the user terminal is the video clip corresponding to the target event thumbnail.

The first viewing operation may be a single action or a series of actions. The second viewing operation may also be a single action or a series of actions. The first viewing operation and the second viewing operation are different actions. For example, the first viewing operation may be a short press, while the second viewing operation may be a long press, but it is not limited to these.

In the above image display method, by displaying an event entry area that includes event thumbnails corresponding to each event, and responding to a viewing operation on a selected target event thumbnail to display an image display page that shows the target event view corresponding to the event of the target event thumbnail, the method may quickly display the image corresponding to a specific event. That is, users may quickly view the target event view corresponding to the selected event thumbnail by viewing the event entry area displayed by the device and selecting and viewing the event thumbnails corresponding to each event in the event entry area, without having to watch the entire video. This effectively reduces the number of user operations, thereby improving the user experience and increasing the viewing rate of video images.

Based on the above embodiments, the image display method in this embodiment may further include: the user terminal responds to a triggering operation on the event entry area by displaying a dynamic album page; the dynamic album page includes event thumbnails corresponding to each of the generated events.

In some embodiments, when the event entry area includes event thumbnails corresponding to multiple events, the event entry area may usually only display a limited number of event thumbnails at the same time. In some scenarios, users need to quickly select the target event thumbnail from multiple event thumbnails. At this time, in response to the user still selects the target event thumbnail in the event entry area, they may encounter the situation where the target event thumbnail is not displayed in the current event entry area. Once this situation occurs, the user has to wait until the target event thumbnail is displayed in the event entry area before they may select it. In this way, users cannot quickly select the target event thumbnail from multiple event thumbnails.

To address the above potential issue, a dynamic album page may be set up. This dynamic album page is configured to display event thumbnails corresponding to each of the generated events. In this way, when users need to quickly select the target event thumbnail from multiple event thumbnails, they may first perform a triggering operation on the event entry area. The user terminal may display the dynamic album page to show the event thumbnails corresponding to each of the generated events to the user. Then, the user may quickly select the target event thumbnail from the dynamic album page. Therefore, compared with performing a viewing operation on the event thumbnails in the event entry area, this embodiment may first provide more options to the user, allowing them to choose to perform a viewing operation on the event thumbnails in the dynamic album page. Meanwhile, since all the generated event thumbnails corresponding to each event are displayed on the dynamic album page, users may quickly select the target event thumbnail from them.

In some embodiments, the user terminal has an application provided by the Internet of Things platform installed, and the dynamic album page may be any page of this application. The user terminal may directly display the dynamic album page on the page that displays the event entry area.

When the number of event thumbnails corresponding to the generated events is large, the user terminal does not have to display all the event thumbnails corresponding to the generated events at the same time. In one embodiment, the dynamic album page includes a single page that may load all the event thumbnails corresponding to the generated events. The user terminal may only display a portion of the event thumbnails at a time. By swiping the dynamic album page, the currently displayed event thumbnails may be changed. In another embodiment, the dynamic album page includes multiple pages that may be navigated between each other, with each page loading a portion of the event thumbnails corresponding to the generated events. The user terminal may display different event thumbnails to the user by presenting different pages.

In other embodiments, the event entry area serves as an entry point for accessing the event images captured by the camera device. The method also includes: the user terminal responds to a triggering operation on the event entry area by displaying an album page corresponding to the camera device; the album page includes at least a dynamic album entry; the user terminal responds to a triggering operation on the dynamic album entry by displaying the dynamic album page; the dynamic album page includes event thumbnails corresponding to each of the generated events.

Specifically, in some embodiments, the user terminal has an application provided by the Internet of Things platform installed, and the album page and the dynamic album page are different pages of this application. The user terminal may directly display the album page on the page that displays the event entry area, and then transition from the album page to the dynamic album page based on the user's triggering operation on the dynamic album entry. It may be understood that the dynamic album page in this embodiment is the same as the dynamic album page in the previous embodiment, and will not be repeated here.

Through the method of this embodiment, not only may a dynamic album page be provided to display the event thumbnails corresponding to each of the generated events to the user, but also an album page may be provided as an intermediate page before transitioning to the dynamic album page. Therefore, compared with performing a viewing operation on the event thumbnails in the event entry area, this embodiment may first provide more options to the user, allowing them to choose to perform a viewing operation on the event thumbnails in the dynamic album page. Meanwhile, since all the event thumbnails corresponding to the generated events are displayed on the dynamic album page, users may quickly select the target event thumbnail from them. Additionally, using the album page as a buffer between the current page displaying the event entry area and the dynamic album page may avoid directly transitioning to the dynamic album page based on a triggering operation on the event entry area.

Based on the above embodiments, the image display method in this embodiment may further include at least one of the following: while the user terminal displays the event entry area, displays event information corresponding to each of the event thumbnails; while displays the target event view on the image display page, displays event information corresponding to the target event image; wherein the event information includes at least one of spatial information, temporal information, and event label information.

Specifically, in some embodiments, when the user terminal displays each event thumbnail through the event entry area, users may select one event thumbnail as the target event thumbnail according to their own needs to view the target event image. However, in some scenarios, users' needs are more complex and involve multiple pieces of information. Moreover, not all of this information may be obtained from the image content of the event thumbnail. For example, in response to the user's need is to find a specific event that occurred at a certain time and place, the user terminal will not be able to select the target event thumbnail that meets the user's needs based solely on the image content of the event thumbnail.

In response to the above potential issues, the user terminal may display event information (such as specific event label information) corresponding to each event thumbnail while displaying the event entry area. This allows users to select the target event thumbnail that meets their needs based on both the image content of the event thumbnail and the corresponding event label information.

The spatial information in the event label information corresponding to the event thumbnail may be the location where the event corresponding to the event thumbnail occurred. For example, the location may be geographical coordinates such as latitude and longitude, or room identifiers. The temporal information in the event label information corresponding to the event thumbnail may be the time when the event corresponding to the event thumbnail occurred. For example, the time may be a timestamp, or time in any time zone. The event information corresponding to the event thumbnail may include information related to the event corresponding to the event thumbnail. For example, the related information may include facial information, pet information, marked faces, marked strangers, etc.

In other embodiments, when the user terminal displays the target event view through the image display page, users may obtain the information they want by viewing the target event image. However, in some scenarios, the information users want cannot be obtained from the target event view alone, or additional information is needed as a reference when viewing the target event image. For example, in response to the user wants to know the time when a certain event occurred at a certain location, displaying only the target event view may not meet the user's needs.

To address the above potential issues, the user terminal may display the event label information corresponding to the target event view while displaying the target event view on the image display page. This allows users to obtain the information they want based on both the target event view and the corresponding event label information. The event label information here is the same as the event label information mentioned above and will not be repeated.

It should be noted that in this embodiment, the user terminal may choose to display the event information corresponding to each event thumbnail while displaying the event entry area to solve the potential problem that users cannot select the target event thumbnail that meets their needs based on the image content of the event thumbnail. The user terminal may also choose to display the event label information corresponding to the target event view while displaying the target event view on the image display page to solve the potential problem that displaying only the target event view cannot meet the user's needs. It may also choose both of the above to solve the two potential problems simultaneously.

In this embodiment, the event label information corresponding to each event thumbnail may be displayed while displaying the event entry area to help users understand the event thumbnails and quickly select the target event thumbnail that meets their needs. The event label information corresponding to the target event view may also be displayed while displaying the target event view on the image display page to help users understand the target event view in more detail.

By displaying the event label information corresponding to each event thumbnail, users may be helped to select the target event thumbnail that meets their needs. By displaying the event label information corresponding to the target event image, users may be provided with more information.

In addition to the above embodiments, in this embodiment, before displaying the event entry area, the image display method further includes: the user terminal responds to a configuration operation triggered on the event entry area by displaying an event configuration page; the event configuration page includes selection controls corresponding to multiple event types; the user terminal responds to triggering operations on the selection controls corresponding to each event type by obtaining the selected event type and binding the selected event type to the event entry area; the bound event type is used for event recognition of the image data captured by the camera device to obtain the event images corresponding to each event.

Specifically, the event type is related to the event, and events under different event types have significant differences. In some embodiments, there is only one event under each event type, so the event type is the event itself. The event types include, but are not limited to: human shape recognition, cat and dog recognition, face recognition, motion detection, door and window opening, and door and window closing. It may be understood that different users may not be interested in exactly the same event types, and even the same user may not be interested in exactly the same event types under different circumstances.

In some embodiments, to avoid missing event types that users may be interested in, the user terminal usually provides a large number of event thumbnails corresponding to events under different event types for users to use, which inevitably involves event types that users are not interested in. For event types that users are not interested in, users usually will not view the event images under these event types. Therefore, this method, due to its lack of targeting, needs to process a large number of event types, resulting in a waste of resources.

To address the above potential issues, in this embodiment, the user terminal may provide an event configuration page. This event configuration page is a page for users to freely configure the event types they may be interested in. Each selection control on the event configuration page corresponds to an event type, and the selection control displays the identifier of its corresponding event type. The identifier of the event type is configured to distinguish different event types and may be text, images, etc. For example, in response to the event type is face recognition, the identifier for this event type may be the words “face recognition” or an image of a face. Users may select the event types they may be interested in from the event configuration page. Then, the user terminal binds the event types that users may be interested in to the event entry area. In this way, only the event types that users may be interested in need to be processed, which is highly targeted for different users and reduces the waste of resources.

In one embodiment, the event types corresponding to each selection control on the event configuration page are all event types that the image capture device may recognize, in order to provide users with the widest range of choices. In another embodiment, the event types corresponding to each selection control on the event configuration page are commonly used event types. These commonly used event types may be obtained by statistically analyzing a large number of different users to identify the event types commonly used by most users, or by analyzing the historical records of the current user to identify the event types commonly used by the current user.

In this embodiment, by providing an event configuration page with multiple event types for users to choose from, users may select the event types they may be interested in and bind them to the event entry area. This way, only the event types that users may be interested in need to be processed, reducing the waste of resources.

The above embodiments illustrate the process of the user terminal displaying event images and the interaction between users and the user terminal from the user's perspective. Correspondingly, this disclosure also provides the generation process and method of the event images displayed by the user terminal.

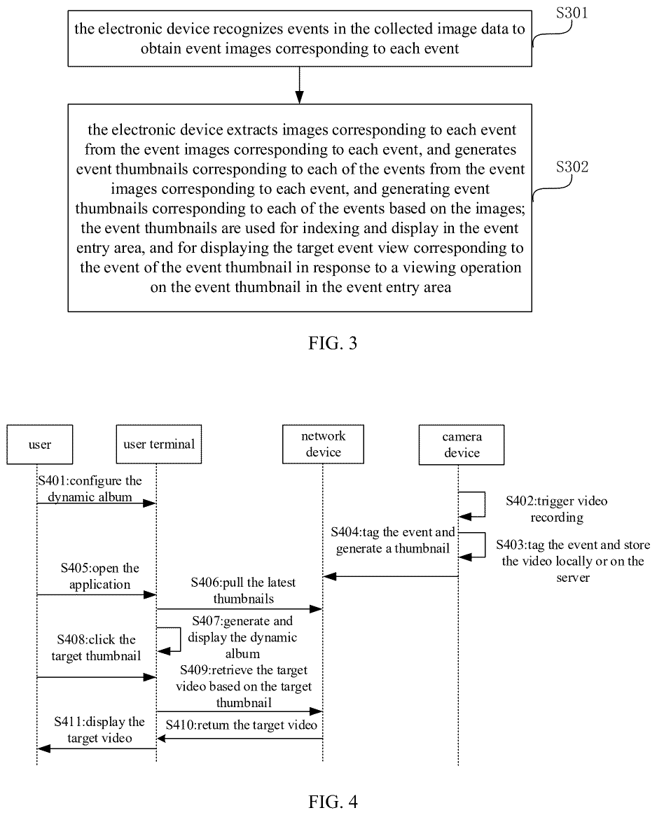

Please refer to FIG. 3. In an exemplary embodiment, an image data processing method is provided, which is illustrated by being applied to an electronic device. This electronic device may specifically be the smart device 110, gateway 120, user terminal 150, or cloud server 140 shown in FIG. 1, or it may be a camera device with specific image data processing capabilities. These electronic devices may all independently execute the image data processing method provided in this embodiment to provide event thumbnails and target event images for the user terminal. For the sake of simplifying the description, the following will refer to the electronic device as a general term for devices such as the smart device 110, gateway 120, user terminal 150, or cloud server 140. Specifically, the image data processing method may be executed by the electronic device, as shown in FIG. 3, and may include the following steps:
Step S301: the electronic device recognizes events in the collected image data to obtain event images corresponding to each event.

The image data is video data captured by a camera device. The electronic device is communicatively connected to the camera device, thereby allowing the electronic device to obtain the video data from the camera device and perform event recognition on the obtained video data. In the implementation environment shown in FIG. 1, the electronic device may be the smart device 110, or it may be the user terminal 150, cloud server 140, or gateway 120 with camera functionality. The camera device may be the smart device 110, or it may be the gateway 120 with camera functionality. It may be understood that the electronic device and the camera device may be the same device. Event recognition refers to the use of image recognition technology to identify events recorded in the image data. The event image corresponding to the event is the part of the image data that records the event.

To facilitate understanding, the specific event of human shape recognition is used here as an example for illustration. Suppose that no one entered or exited a certain doorway from 10:00 AM to 2:00 PM on Jan. 1, 2023, but from 2:00 PM to 3:00 PM on the same day, people kept entering and exiting continuously. The camera device was aimed at the doorway and captured video from 10:00 AM to 3:00 PM on Jan. 1, 2023, generating a video file. This video file is the image data collected in this step. The electronic device performs human shape recognition on the video file and may identify that a certain time period within the video file records the human shape recognition event. The video data within this time period is the event image corresponding to the human shape recognition event.

In some embodiments, in the above step S301, the electronic device recognizes events in the collected image data to obtain event images corresponding to each event, which may include: the electronic device obtains image data and sequentially performing event recognition on multiple frames of the image data, extracting video clips corresponding to each event based on the recognition results, and using these video clips as the event images corresponding to each event; or, obtains image data and sequentially performing event recognition on multiple frames of the image data, marking video clips corresponding to each event in the image data based on the recognition results, and using these marked video clips as the event images corresponding to each event.

Specifically, the image data captured by the camera device may be a complete video that records multiple events. It may also be multiple segments of video, each recording a single event. For different situations, different processing methods are required. In some embodiments, the image data captured by the camera device is a complete video that records multiple events. At this time, the electronic device needs to determine which segment of the video each event corresponds to based on event recognition. Then, the segments corresponding to each event are extracted from the video as the event images corresponding to each event. In one embodiment, for this complete video, the electronic device extracts one frame per second to obtain multiple frames, and then performs event recognition on the multiple frames to determine whether each frame records an event and which event it records. The electronic device counts the continuous frames that record the same event and the corresponding time period. For each time period, the video clip within that time period is determined as the event image corresponding to the event. It may be understood that the method for the electronic device to extract frames from the video is not limited to the above-mentioned one frame per second. In another embodiment, the electronic device may extract multiple frames per second. After performing event recognition on the multiple frames extracted per second, one of them is selected as a representative for subsequent counting of the continuous frames that record the same event and the corresponding time period.

The solution of this embodiment is applicable to camera devices that only have image data collection capabilities, that is, it is applicable to devices such as cameras that may only perform shooting. In this case, the camera device is only responsible for collecting complete image data and then sending the collected image data to the electronic device for subsequent processing.

In other embodiments, the image data captured by the camera device consists of multiple video segments, each recording a single event. In this case, since each video records a single event, it is only necessary to extract at least one frame from each video for event recognition. Then, based on the event recognition results, the specific event recorded in the video may be determined and marked.

The solution of this embodiment is applicable to camera devices that have both image data collection capabilities and event recognition capabilities, that is, it is applicable to devices such as cameras that may only analyze and process the captured videos. In this case, the camera device may recognize the captured video. In response to an event/frame that meets the requirements is recognized, the corresponding video is stored to obtain a video that records a single event; while the rest of the videos that do not meet the requirements are discarded and not stored. Subsequently, the camera device may send the stored video and other image data to the electronic device for subsequent processing.

Therefore, whether the image data is a complete video recording multiple events or multiple video segments each recording a single event, it is only necessary to determine the video segments corresponding to each event after event recognition. Then, the video segments may be extracted to form new videos for subsequent processing, thereby avoiding any impact on the original video. Alternatively, the video segments may be marked within the original video, and the original video marked with the video segments may be used directly for subsequent processing, thus eliminating the need to generate additional videos.
Step S302: the electronic device extracts images corresponding to each event from the event images corresponding to each event, and generates event thumbnails corresponding to each of the events from the event images corresponding to each event, and generating event thumbnails corresponding to each of the events based on the images; the event thumbnails are used for indexing and display in the event entry area, and for displaying the target event view corresponding to the event of the event thumbnail in response to a viewing operation on the event thumbnail in the event entry area.

The event images corresponding to an event usually include multiple frames, and the event thumbnail corresponding to the event is one of these frames. It should be noted that the indexing display of the event thumbnail in the event entry area, the response to the viewing operation on the event thumbnail in the event entry area, and the display of the target event view corresponding to the event of the event thumbnail in this step may all refer to the embodiments of the above image display method, and will not be repeated here.

In some embodiments, in the above step S302, the electronic device extracts images corresponding to each event from the event images corresponding to each event and generates event thumbnails corresponding to each event based on the images, which may include: the electronic device extracts all frames of images included in the video clip corresponding to the current event, and analyzing each frame of images corresponding to the current event to obtain multiple frames of images that meet the extraction conditions; wherein the extraction conditions include at least one of the following: the clarity of the event subject is greater than the preset clarity, and the proportion of the event subject is greater than the preset proportion; selects one frame of image from the multiple frames of images that meet the extraction conditions as the event thumbnail for the current event.

Specifically, for each event, although all frames of images included in the video clip corresponding to the event record the event, there are some differences in the quality of each frame of images. The image of the event thumbnail needs to be displayed to the user. To help users accurately obtain the image content of the event thumbnail, it is necessary to screen out images of better quality as event thumbnails.

It may be understood that the higher the clarity of the event subject, the clearer the event subject is. Correspondingly, the easier it is for users to distinguish the event subject in the image, the better the quality of the image to which the event subject belongs should be. The larger the proportion of the event subject, the more prominent the event subject is. Correspondingly, the easier it is for users to distinguish the event subject in the image, the better the quality of the image to which the event subject belongs should be. Therefore, the parameters for measuring image quality include, but are not limited to, the clarity of the event subject and the proportion of the event subject.

In this embodiment, the preset clarity is a predetermined clarity threshold. This preset clarity is configured to measure whether the image is clear or blurry. In response to the clarity of a certain image exceeds the preset clarity, the image may be regarded as a clear image. The preset proportion is a predetermined proportion threshold. This preset proportion is configured to measure whether the event subject is prominent. In response to the proportion of the event subject in a certain image exceeds the preset proportion, it may be regarded as the event subject being prominent in the image.

In this embodiment, by screening based on at least one of clarity and the proportion of the event subject in the video clip corresponding to the event, images that are clear and have at least one of the prominent event subjects may be obtained, and then used as event thumbnails, thereby ensuring the image quality of the event thumbnails.

In some embodiments, after determining the event thumbnail, the electronic device may also label the event thumbnail with event label information. Here, the event label information includes at least one of spatial information, temporal information, and event information. The spatial information may be the location where the event corresponding to the event thumbnail occurred. The location may be geographical coordinates such as latitude and longitude, room identifiers, etc. The temporal information may be the time when the event corresponding to the event thumbnail occurred.

The occurrence time may be a timestamp, time in any time zone, etc. Event information may be information related to the event corresponding to the event thumbnail. The related information of the event may be facial information, pet information, marked faces, marked strangers, etc. In other embodiments, the event label information may also include: the name and index address of the event image corresponding to the event thumbnail.

In the above image data processing method, the electronic device recognizes events in the collected image data to obtain event images corresponding to each event. Then, the electronic device extracts images corresponding to each event from the event images corresponding to each event and generates event thumbnails corresponding to each event based on the images. The user terminal may help users quickly locate the image corresponding to a specific event by indexing and displaying the event thumbnails in the event entry area. That is, users may quickly view the target event view corresponding to the selected event thumbnail by selecting and viewing the event thumbnails corresponding to each event in the event entry area displayed by the user terminal, without having to watch the entire video. This may effectively reduce the number of user operations, thereby improving the user experience and increasing the viewing rate of video images.

Based on the above embodiments, the image data processing method in this embodiment further includes: the electronic device combines at least a portion of the event thumbnails corresponding to each of the events to generate an event snapshot collection; the event snapshot collection is used for dynamic sequential display in the event entry area, and for displaying the target event view corresponding to the event of the currently displayed event thumbnail in the event entry area in response to a viewing operation on the currently displayed event thumbnail.

Specifically, the user terminal may dynamically and sequentially display part or all of the event thumbnails corresponding to each event in the event entry area in the form of a collection. In some embodiments, when selecting event thumbnails to be included in the event snapshot collection, the user terminal may choose event thumbnails obtained from event images captured recently based on the capture time of the event images. For example, the user terminal may screen out event thumbnails obtained from event images captured within the last month and combine them to generate an event snapshot collection. Of course, the capture time is not limited to the last month. Users may also set the capture time according to their own needs.

In this embodiment, choosing to dynamically and sequentially display part of the event thumbnails corresponding to each event in the event entry area not only facilitates users in selecting among different event thumbnails but also makes the user's selection range more flexible and varied.

### Exemplary Application Scenarios

Referring to FIG. 4, this disclosure also provides an application scenario that may combine the above image display method and image data processing method, enabling users to view the corresponding event images according to their own needs. Taking the electronic device as a camera device as an example, the camera device may record videos and store the recorded videos in its storage unit. Both the camera device and the user terminal are communicatively connected to a network device, which may be a cloud server or a gateway. The gateway may refer to the home hub in the Internet of Things platform, which has strong processing capabilities. It should be noted that this gateway may be different devices in the Internet of Things platforms provided by different merchants, and no limitation is made here. The user terminal has an application installed, through which the user terminal may access the data stored on the network device.

As shown in FIG. 4, the application of the above method in this application scenario is as follows:
Step S401: the user configures the dynamic album.

In this step, the user may configure one or more events that they may be interested in through the application on the user terminal. Specifically, when the dynamic album has not yet been configured, the user may enter the event configuration page through the dynamic album control in the application, and then configure the dynamic album on the event configuration page according to their own needs.

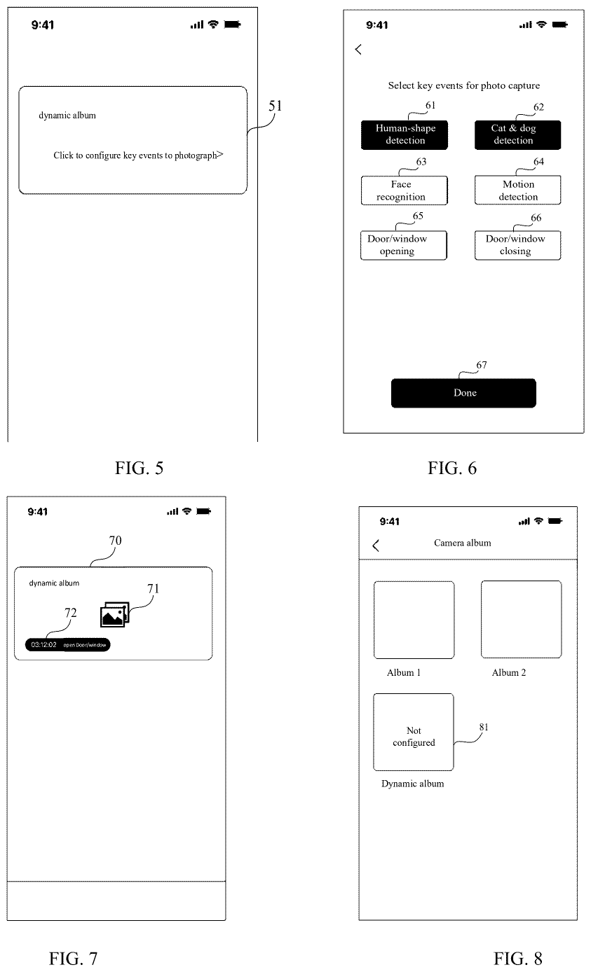

As shown in FIG. 5, a dynamic album control 51 may be provided on the home page of the application. When the dynamic album has not yet been configured, the dynamic album control 51 displays a prompt for the user to configure, such as the phrase “Click to configure key events to photograph” shown in FIG. 5.

By clicking the dynamic album control 51, the event configuration page shown in FIG. 6 may be displayed. The event configuration page includes a first selection control 61 corresponding to human shape recognition, a second selection control 62 corresponding to cat and dog recognition, a third selection control 63 corresponding to face recognition, a fourth selection control 64 corresponding to motion detection, a fifth selection control 65 corresponding to door and window opening, and a sixth selection control 66 corresponding to door and window closing. After the user selects the first selection control 61 and the second selection control 62, they may complete the configuration of the dynamic album by clicking the completion control 67. Of course, FIG. 6 is only an example, and the event configuration page of this disclosure is not limited to the selection controls shown in FIG. 6.

After the dynamic album is configured, the dynamic album control on the home page is shown in FIG. 7. The dynamic album control 70 displays a thumbnail 71 and video information 72 corresponding to the thumbnail. The phrase “Click to configure key events to photograph” disappears.

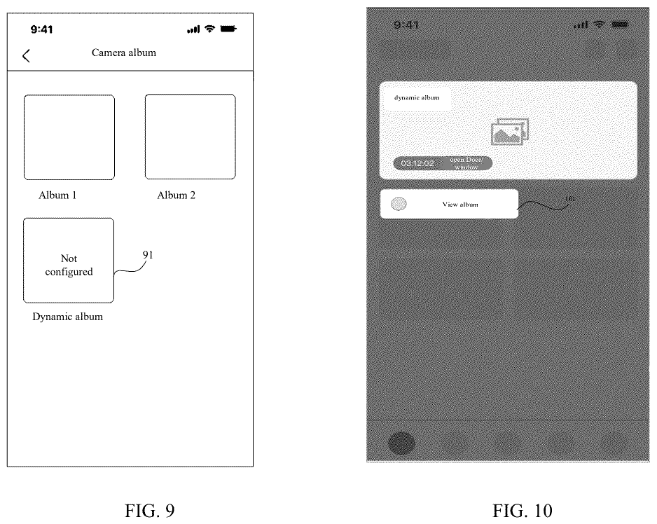

Similarly, as shown in FIG. 8, a dynamic album control 81 may also be provided on the camera album page. When the dynamic album has not yet been configured, the dynamic album control 81 displays a prompt for the user to configure, such as the phrase “Not Configured” shown in FIG. 8. By clicking the dynamic album control 81, the event configuration page shown in FIG. 7 may also be displayed. It should be noted that after the dynamic album is configured, the dynamic album control changes accordingly. As shown in FIG. 9, the phrase “Not Configured” disappears from the dynamic album control 91.
Step S402: The camera device triggers video recording according to the configuration information.

After the dynamic album is configured, the camera device will start recording video when it detects the configured event and stop recording after the event ends, thereby obtaining a video that records the event. The event detected here is the event configured in the above step S401. After the user configures the relevant event on the user terminal, the configuration information may be transmitted to the camera device. For example, the configuration information is transmitted to the camera device via the network device.

Specifically, the camera device performs algorithmic recognition processing on the key frame images captured by the camera device through its local artificial intelligence recognition algorithm. For example, three video frames may be taken within 1 second, and then the images of the video frames are recognized to determine whether the images of the video frames contain any of the events configured by the user. The artificial intelligence recognition algorithm here is obtained through model training in advance and may be used as a model algorithm for recognizing various events. When it is determined that the image of a video frame contains any of the events configured by the user, the recording function is triggered. Since the data transmission process takes time, there will be a millisecond-level delay after receiving the signal, which means that there is a risk that the camera device may not be able to capture the image in the first place. In this embodiment, the camera device has a 2-second buffer queue set up locally. After the recording function is triggered, the camera device may find the past records in the buffer queue, which may greatly reduce the risk of discarding important images.
Step S403: the camera device performs event marking and stores the video.

The camera device stores the recorded video locally or on a cloud server, and then performs event marking on each recorded video. The marked information includes, but is not limited to: the event identifier of the event in the video, timestamp, video name, storage path of the video, and index. Finally, the videos and the marked information are sent to the network device.
Step S404: the network device performs event marking and generates thumbnails.

The network device processes each received video separately to obtain the thumbnail corresponding to each video. Here, only the processing of one video is taken as an example for illustration. First, artificial intelligence recognition is performed on the video to extract the video frame in which the event subject is the clearest and the proportion of the event subject in the image is the largest. Then, the extracted video frame is used as the thumbnail corresponding to the video. In response to more than one video frame is extracted, any one of them may be chosen as the thumbnail corresponding to the video. Here, when determining the clarity of the event subject, a preset algorithm may be configured to calculate the edge jaggedness of the event subject in the image, and the clarity of the event subject may be determined based on the edge jaggedness. The proportion of the event subject in the image is the percentage of the size of the event subject to the size of the entire image of its corresponding video frame.

The network device may automatically merge all thumbnails of the day every 24 hours, extract the thumbnail detail information corresponding to each thumbnail, and then merge these independent thumbnails into one file to generate a dynamic album and an array in the order of the thumbnails. This array is recorded in a JSON (JavaScript Object Notation) file. The elements of this array contain the thumbnail detail information corresponding to each thumbnail. The thumbnail detail information includes event labels, local paths of the corresponding videos, indexes, and corresponding timestamps. Event labels may include spatial information (room, latitude and longitude), temporal information (timestamp, local time zone), and event information (facial information, pet information, marked faces or strangers, etc.). After generating the dynamic album, a notification may be pushed to the user terminal's notification bar.
Step S405: the user opens the application.
Step S406: the user terminal pulls the recently generated thumbnails from the network device.

Here, “recently” may refer to the last day, week, etc. Specifically, the dynamic album and its corresponding JSON file stored recently on the network device will be pulled. When the user clicks on the dynamic album notification in the user terminal's notification bar or triggers the dynamic album control by opening the application, the recently stored dynamic album and its corresponding JSON file are obtained from the network device.
Step S407: based on the recently generated thumbnails, a dynamic album is generated and displayed.

The thumbnails obtained in Step S406 from the dynamic album are displayed in the dynamic album control of the application. In this way, users may know which events'videos have been recorded recently by viewing the dynamic album control.
Step S408: the user clicks on the target thumbnail in the dynamic album control.

Since the thumbnails in the dynamic album control are dynamically displayed, users may choose and click on a thumbnail according to their own needs. The thumbnail selected by the user is the target thumbnail.
Step S409: the user terminal sends the thumbnail detail information corresponding to the target thumbnail in the JSON file to the network device. The network device uses the thumbnail detail information to retrieve the corresponding target video.
Step S410: the network device returns the retrieved target video to the user terminal.
Step S411: the user terminal displays the target video to the user.

It should be noted that to avoid accidental triggering of the thumbnails in the dynamic album control by the user, a prompt message may be displayed after the user clicks on the target thumbnail, asking whether the user wants to view the target video corresponding to the target thumbnail. When the user chooses to view the target video, the camera device's storage unit finds the corresponding target video file based on the video storage path and index in the thumbnail detail information. Then, the target video is played on the user terminal. When the user clicks to jump to the recording position, the corresponding position on the timeline may be located based on the timestamp for event playback. Ideally, when displaying the target video, the corresponding position in the target video may be found based on the timestamp in the thumbnail detail information corresponding to the target thumbnail, and the target video may be played from that position. For example, in response to the timestamp indicates the seventh minute of the target video, the target video will start playing from the seventh minute.

In some scenarios, users may only need to take a detailed look at the thumbnails. Therefore, an entry for users to carefully view the thumbnails may also be provided. Specifically, when the dynamic album has been configured, the entry to view the thumbnails may be provided through the dynamic album control on the home page. The entry may also be provided through the dynamic album control on the camera album page. Additionally, a dedicated functional control may be set up on the home page to provide an entry for viewing the thumbnails.

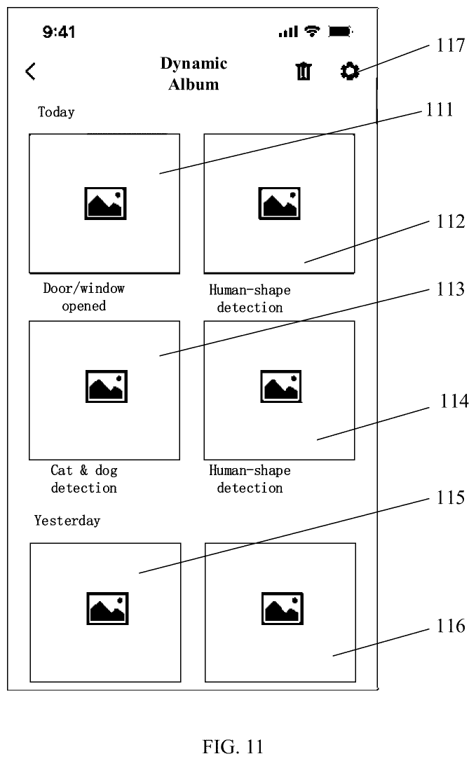

For example, when the user opens the page shown in FIG. 7, a long press on the dynamic album control 70 may display the page shown in FIG. 10, further asking the user whether to enter the album page. After the user clicks on the view album control 101, the album page shown in FIG. 11 is entered. The album page simultaneously displays multiple thumbnails for users to view and select, such as the thumbnail 111 corresponding to the “door and window opening” event, the thumbnail 112 corresponding to the “human shape recognition” event, the thumbnail 113 corresponding to the “cat and dog recognition” event, another thumbnail 114 corresponding to the “human shape recognition” event, and the thumbnails 115 and 116 corresponding to the other two events. After the user clicks on one of the thumbnails, the enlarged image of that thumbnail will be displayed for the user to view. For example, after the user clicks on the thumbnail 111, the page shown in FIG. 12 will be displayed, and then the enlarged image of the thumbnail corresponding to the door and window opening will be shown. Similarly, when the user opens the page shown in FIG. 9, clicking on the dynamic album control 91 may display the page shown in FIG. 10. For details about FIG. 10, please refer to the above description, which will not be repeated here.

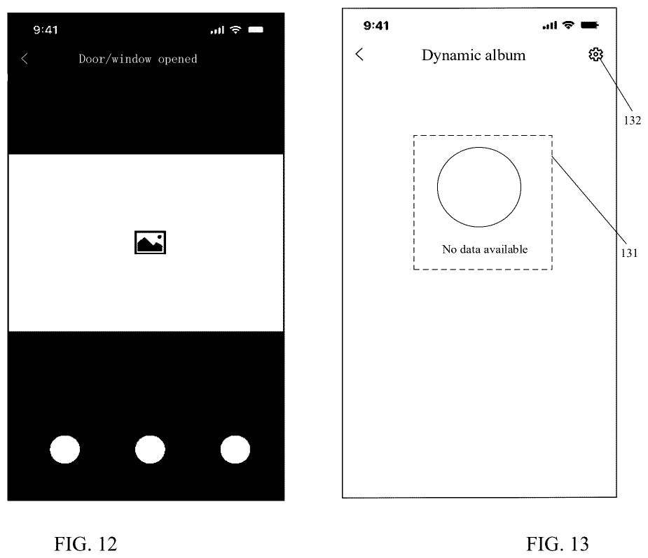

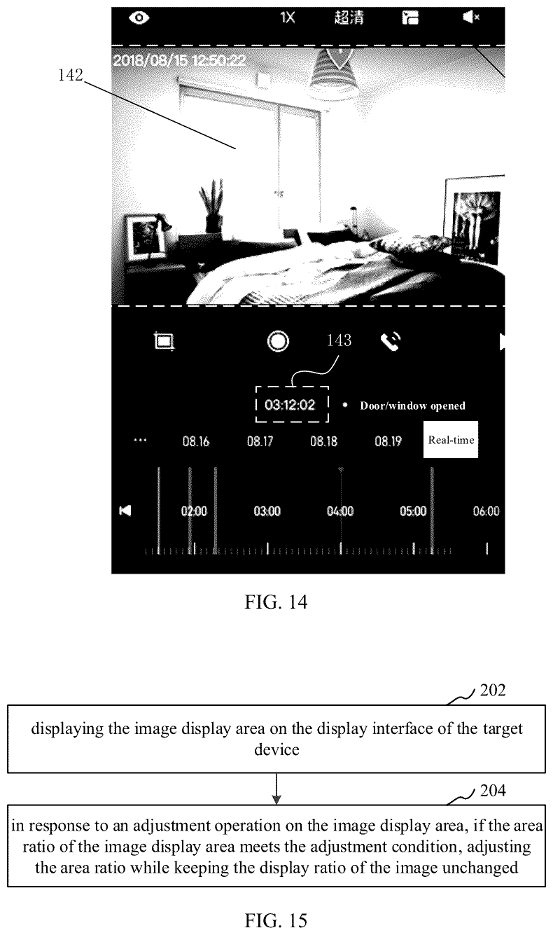

It should be noted that when there are thumbnails, the album page, as shown in FIG. 11, may display which thumbnails are available. When there are no thumbnails, the album page, as shown in FIG. 13, displays the phrase “No data available” in the target area 131. Ideally, as shown by the setting controls 117 in FIGS. 11 and 132 in FIG. 13, a setting control may be designed in the upper right corner of the album page to enter the event configuration page shown in FIG. 6 for further configuration.

In some implementations, when the user opens the page shown in FIG. 7, a long press on the dynamic album control 70 may provide an entry for the user to carefully view the thumbnails. Clicking on the dynamic album control 70 may enter the video playback page to play the video that records the event and adjust the playback progress to the position where the event occurs. Suppose the user clicks on the dynamic album control 70 in FIG. 7 when it displays the first thumbnail. The first thumbnail is the thumbnail corresponding to the “door and window opening” event. After clicking, the playback page may be jumped to play the video that records the “door and window opening” event and adjust the playback progress to the position where the “door and window opening” event occurs.

As shown in FIG. 14, the video image 141 displayed on the playback page shows the window 142 being opened. Moreover, through the specific data displayed in the playback area 143, it may be determined that the current video image 141 is at the playback position of 03:12:02 in the entire video. That is to say, the playback progress has been adjusted to the position where the “door and window opening” event occurs.

In this embodiment, users may select the key events they are interested in, and then mark and store the key events in the images captured by the camera device through event recognition. event thumbnails are generated for each event based on the video frames in the video, and a dynamic album is generated using these event thumbnails and displayed to the user. The event thumbnails may be automatically played without user operation, and when the user clicks on an event thumbnail in the dynamic album, the corresponding video image may be quickly indexed without having to watch the entire video. Therefore, this may effectively reduce the number of user operations, thereby improving the user experience and increasing the viewing rate of video images.

It should be understood that although the steps in the flowcharts of FIG. 2 and FIG. 4 and FIG. 4 are displayed in sequence according to the arrows, these steps are not necessarily executed in the order indicated by the arrows. Unless explicitly stated in this article, there is no strict order limit on the execution of these steps, and they may be executed in other orders. Moreover, at least some of the steps in FIG. 2 and FIG. 4 and FIG. 4 may include multiple sub-steps or stages, which do not necessarily have to be completed at the same time, but may be executed at different times. The execution order of these sub-steps or stages is not necessarily sequential, but may be alternated or interleaved with other steps or at least some of the sub-steps or stages of other steps.

### Exemplary Method

In an exemplary embodiment, as shown in FIG. 15, an image processing method is provided. This embodiment illustrates the method as applied to a user terminal. It should be understood that the method may also be applied to a server or a system including both a terminal and a server, and may be realized through the interaction between the terminal and the server. In this embodiment, the image display page includes an image display area, the method includes the following steps:
Step 202: displaying the image display area on the display interface of the target device, the image display area being configured to display at least one of the images captured by the camera device and the target event view corresponding to the event of the target event thumbnail.

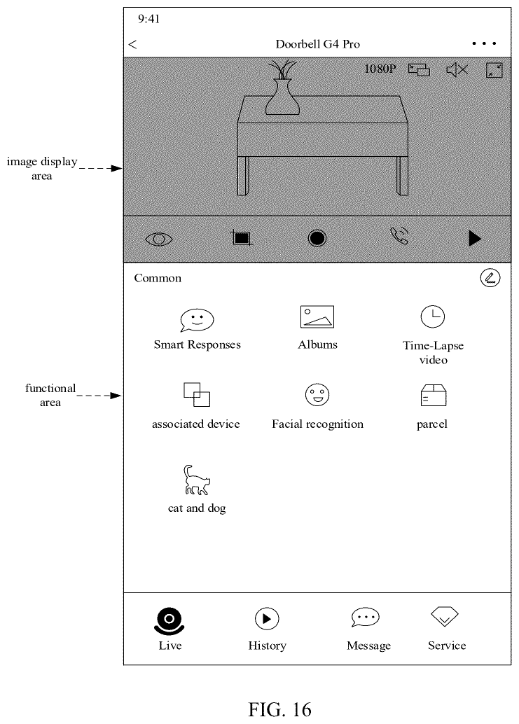

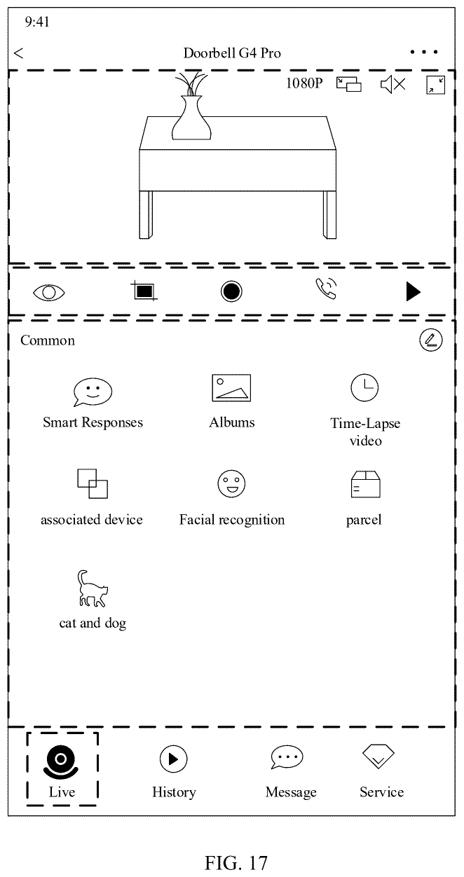

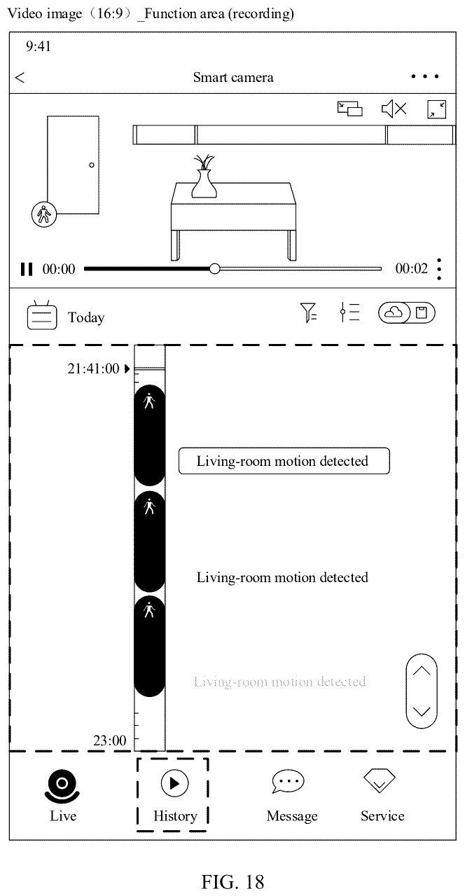

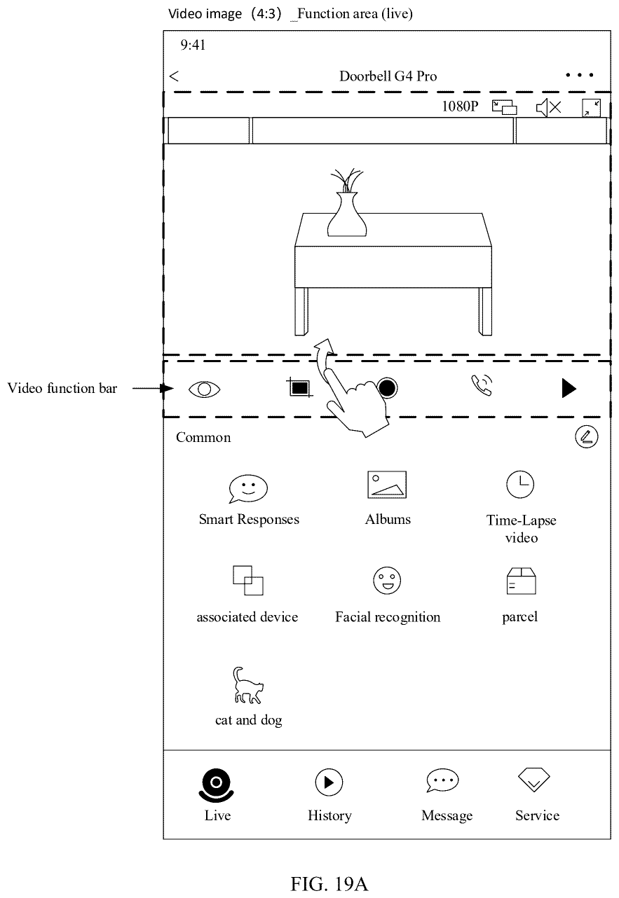

The target device may be a user terminal, such as a mobile phone or tablet computer. The target device may have an application installed, for example, a surveillance app. Users may register and log in to the user account of this application on the target device. Consequently, users may trigger a login request on the target device. In response to the login request, the user terminal may display the login interface for the application, where the user may input a username and password to log in. Upon successful user login, the display interface of the application may be shown on the target device. As shown in FIG. 16, the display interface may feature an image display area, which is designed to present images captured by the capture device (e.g., a camera). These images may include real-time still images and videos from the camera, such as a view of the living room. The image display area may incorporate a video function bar, which may contain at least one video function button. These buttons may correspond to inherent camera functions of the capture device (e.g., a camera), such as privacy, screenshot, recording, call, and pause/play. Additionally, the display interface of the application may also showcase a functional area. The sum of the area ratio of the image display area (i.e., the proportion of the image display area in the display interface) and the area ratio of the functional area remains constant. The functional area may include a function bar, which may consist of at least one function implementation button. These buttons may represent commonly used functions of the application, such as Live, History, Message, and Service. The Live button may encompass at least one real-time operation function button, for example, Smart Responses, Albums, Time-Lapse Video, associated device, Facial recognition, parcel, and cat and dog. These real-time operation function buttons may be configured to adjust the capture operations of the capture device and to adjust and process the images displayed in the image display area. As shown in FIG. 17, triggering the Live button may display the at least one real-time operation function button in the functional area of the display interface and may show the real-time captured image from the capture device (e.g., a camera) in the image display area of the display interface. As shown in FIG. 18, triggering the History button may display the spatial status information of the target space in the functional area in the form of a timeline for a historical time period, such as human activity information (e.g., baby crying detected at 23:30:00, activity in the living room detected at 21:41:00), and may display the captured image of the capture device during the historical time period in the image display area. It should be noted that the capture device may be the camera device mentioned in the above embodiments. Displaying images from the capture device may include displaying the target event view corresponding to the event of the target event thumbnail as described in the above embodiments.
Step 204: in response to an adjustment operation on the image display area, if the area ratio of the image display area meets the adjustment condition, adjusting the area ratio while keeping the display ratio of the image unchanged; the area ratio is configured to indicate the proportion of the image display area in the display interface; the display ratio of the image is configured to indicate the display ratio of the image itself.

In this step, the user may trigger an adjustment operation on the image display area on the display page of the application. This adjustment operation is configured to instruct the user terminal (i.e., the target device) to adjust the area ratio of the image display area on the display interface. The area ratio indicates the proportion of the image display area in the display interface. In response to the adjustment operation on the image display area, the target device may obtain the current area ratio of the image display area and may determine whether the current area ratio meets the adjustment condition. if the area ratio of the image display area meets the adjustment condition, the area ratio of the image display area is adjusted. During the process of adjusting the area ratio of the image display area, the relative proportion of the image to the image display area will also change accordingly, but the display ratio of the image itself remains unchanged. The display ratio of the image indicates the display ratio of the image itself, such as the width-to-height ratio of the image.

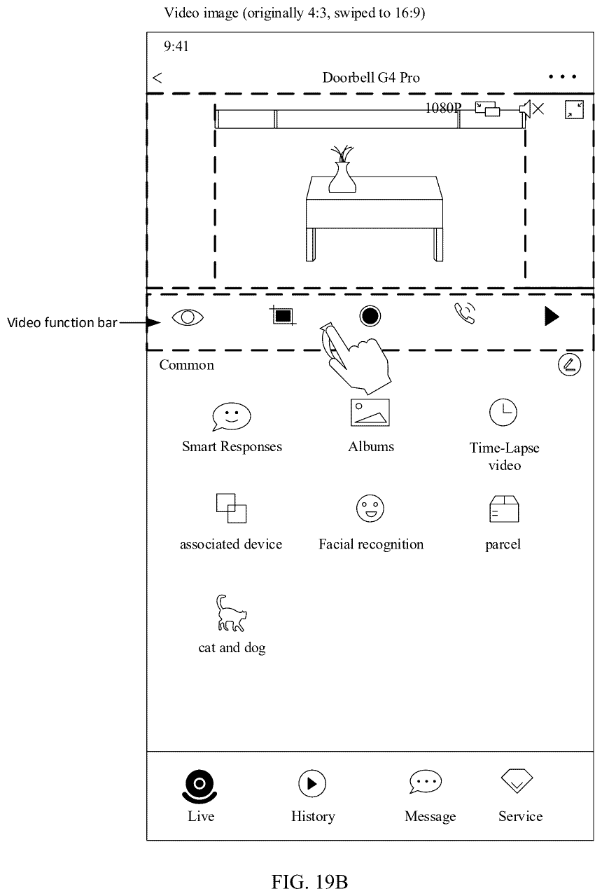

Regarding the manner in which the user triggers an adjustment operation on the image display area on the display interface, in one possible implementation, as shown in FIG. 19A and FIG. 19B, the user may adjust the area ratio of the image display area by sliding within the video function bar on the display interface. This sliding may be in the vertical direction (up and down) or the horizontal direction (left and right). It may be set that sliding upwards and/or to the left corresponds to reducing the area ratio of the image display area. Conversely, sliding downwards and/or to the right may be set to increase the area ratio of the image display area. When reducing the area ratio of the image display area, in response to the total size of the display interface remains unchanged, the functional area ratio of the display interface will correspondingly increase. When increasing the area ratio of the image display area, in response to the total size of the display interface remains unchanged, the functional area ratio of the display interface will correspondingly decrease. The adjustment condition may be configured to determine whether the current area ratio of the image display area may be adjusted. In response to the area ratio of the image display area meets the adjustment condition, the area ratio of the image display area is adjusted while maintaining the display ratio of the image and the integrity of the image. The display ratio of the image may be determined based on the display ratio of the capture device that captured the image. Different capture devices may have different display ratios. For example, the display ratio may include 16:9, 4:3, 1:1, etc., and correspondingly, the display ratio of the image may also include 16:9, 4:3, 1:1, etc. For instance, in response to the inherent display ratio of the image captured by the capture device is 4:3, when the capture device sends the captured image to the target device for display, the display ratio of the image displayed on the display interface of the target device will also be 4:3. Moreover, when adjusting the area ratio of the image display area, the display ratio of the image is kept at 4:3.

In the method of this embodiment, an image display area is displayed on the display interface of the target device. The image display area is configured to display images from the capture device. In response to an adjustment operation on the image display area, if the area ratio of the image display area meets the adjustment condition, the area ratio is adjusted while keeping the display ratio of the image unchanged. The area ratio is configured to indicate the proportion of the image display area in the display interface, and the display ratio of the image is configured to indicate the display ratio of the image itself. In the method provided by this embodiment of the present disclosure, the area ratio of the image display area on the display interface of the target device may be flexibly adjusted according to needs. This allows users to operate the display interface without being restricted by the inherent area ratio of the image display area. By changing the area ratio of the image display area on the display interface, it becomes more convenient to view and operate the image within the image display area, as well as to operate other areas of the display interface. This enhances the convenience of operations on the display interface. At the same time, it does not distort the display ratio of the image within the image display area, preventing the image from stretching or deforming.

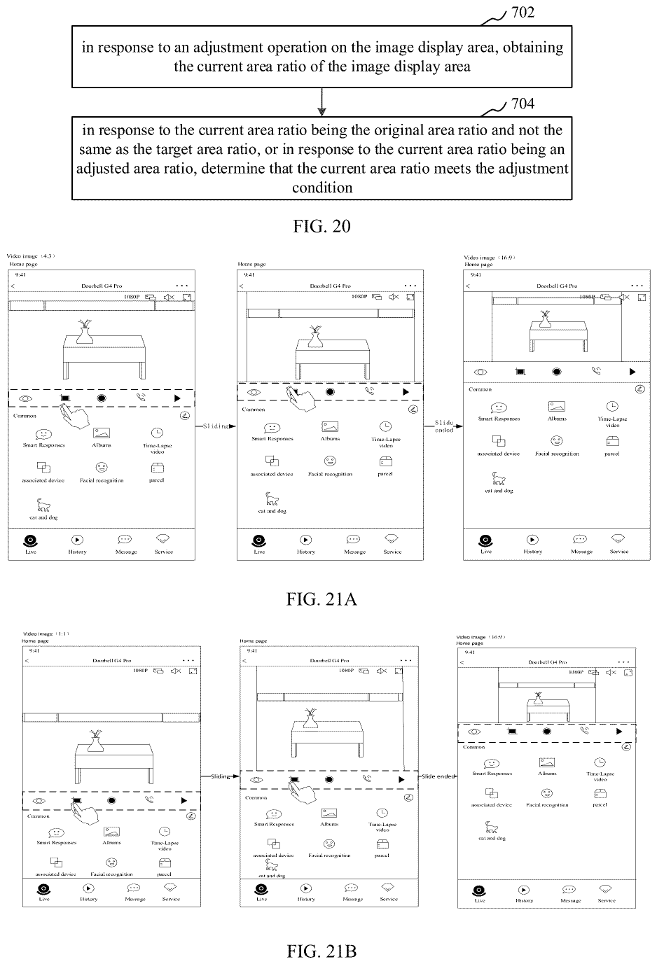

In an exemplary embodiment, as shown in FIG. 20, prior to adjusting the area ratio if the area ratio of the image display area meeting the adjustment condition in step 204, steps 702 to 704 may also be included. Wherein:
Step 702: in response to an adjustment operation on the image display area, obtaining the current area ratio of the image display area.

Here, in response to an adjustment operation on the image display area, the target device may obtain the current area ratio of the image display area.
Step 704: in response to the current area ratio being the original area ratio and not the same as the target area ratio, or in response to the current area ratio being an adjusted area ratio, determine that the current area ratio meets the adjustment condition.

The original area ratio is the area ratio of the image display area in its original state before any adjustment. The target area ratio may be the area ratio of the image display area when a specific display ratio of the image fills the image display area. The specific display ratio of the image may be 16:9.

In one possible implementation, in response to the original area ratio of the image display area is the same as the target area ratio, it indicates that the current area ratio of the image display area does not meet the adjustment condition. In this case, the current area ratio of the image display area may be maintained. In response to the original area ratio of the image display area is not the same as the target area ratio, it indicates that the current area ratio of the image display area meets the adjustment condition. In this case, the current area ratio of the image display area may be adjusted. In another possible implementation, in response to the current area ratio of the image display area is an adjusted area ratio, it indicates that the current area ratio of the image display area meets the adjustment condition. In this case, the current area ratio of the image display area may be adjusted. For example, in response to the target area ratio is the area ratio that may fill the image display area with a display ratio of 16:9, and the current area ratio of the image display area is the original area ratio (which may be, for example, the area ratio that fills the image display area with a display ratio of 4:3, or it may also be the area ratio that fills the image display area with a display ratio of 1:1), then in response to an adjustment operation on the image display area, the current area ratio of the image display area may be adjusted to the target area ratio. In response to the current area ratio of the image display area is an adjusted area ratio, it may also be adjusted back to the original area ratio.

In the method of this embodiment, a specific display ratio of the image may be preset, and the target area ratio may be set according to this specific display ratio. Based on the original area ratio and the target area ratio of the image display area, it may be determined whether the current area ratio of the image display area meets the adjustment condition. Consequently, the area ratio may be correspondingly adjusted, which may enhance the flexibility and simplicity of the area ratio adjustment.

In an exemplary embodiment, after obtaining the current area ratio of the image display area in step 702, the following may also be included:

In response to the current area ratio being the original area ratio and the same as the target area ratio, it is determined that the current area ratio does not meet the adjustment condition.

Here, in response to the original area ratio of the image display area is the same as the target area ratio, it indicates that the current area ratio of the image display area does not meet the adjustment condition. In this case, the current area ratio of the image display area may be maintained. For example, in response to the original area ratio of the image display area is the area ratio that fills the image display area with a display ratio of 16:9, and the target area ratio is also the area ratio that fills the image display area with a display ratio of 16:9, then the current area ratio of the image display area may be kept as the original area ratio.

Different scenarios may be discussed. In response to the original area ratio of the image display area is the same as the target area ratio, there is no need to adjust the current area ratio of the image display area. This may enhance the diversity, flexibility, and simplicity of the area ratio adjustment.

In an exemplary embodiment, in step 204, in response to an adjustment operation on the image display area, and in response to the area ratio of the image display area meeting the adjustment condition, the area ratio is adjusted, which may include:

The adjustment operation includes a first adjustment operation; the first adjustment operation is configured to reduce the area ratio. In response to the first adjustment operation, and in response to the current area ratio being greater than the target area ratio, the current area ratio is reduced to the target area ratio. Alternatively, the adjustment operation includes a second adjustment operation; the second adjustment operation is configured to increase the area ratio. In response to the second adjustment operation, and in response to the current area ratio being the target area ratio, the current area ratio is increased to the original area ratio.

The first adjustment operation may be the user sliding upwards in the video function bar; this first adjustment operation may be configured to reduce the current area ratio of the image display area. Correspondingly, the second adjustment operation may increase the current area ratio of the image display area. For example, as shown in FIG. 21A and FIG. 21B, the current area ratio of the image display area may be, for example, the area ratio that fills the image display area with a display ratio of 4:3, or it may also be the area ratio that fills the image display area with a display ratio of 1:1. This current area ratio may also be the original area ratio of the image display area. The target area ratio may be the area ratio that fills the image display area with a display ratio of 16:9. At this time, the current area ratio is greater than the target area ratio, and the current area ratio may be reduced to the target area ratio. During the sliding process, the current area ratio of the image display area continuously decreases until it reaches the target area ratio. In response to the user stopping the slide, the current area ratio of the image display area may be automatically converted to the target area ratio. During this process, the non-image area of the image display area may be filled with a background, such as a color, which may be black. The non-image area is the area of the image display area other than the image.

The second adjustment operation may be the user sliding downwards in the video function bar. This second adjustment operation may be configured to increase the area ratio of the image display area. For example, the current area ratio is the target area ratio (the area ratio that fills the image display area with a display ratio of 16:9), and this current area ratio may be an adjusted area ratio, for example, it may be adjusted from the area ratio that fills the image display area with a display ratio of 4:3 (which may be the original area ratio) to the target area ratio. At this time, the user slides downwards in the video function bar, and the current area ratio of the image display area may be increased to its original area ratio. During this process, the current area ratio of the image display area is continuously increasing and may be increased to the original area ratio of the image display area.

In the method of this embodiment, the area ratio of the image display area on the display interface of the target device may be flexibly adjusted, which may enhance the flexibility and simplicity of image adjustment.

In an exemplary embodiment, following the adjustment of the area ratio as described above, the method may further include:

In response to a first return operation or a second return operation on the image display area, the area ratio of the image display area is restored to the original area ratio, or the area ratio is restored to the target area ratio. The first return operation is the reverse operation of the first adjustment operation, and the second return operation is the reverse operation of the second adjustment operation.

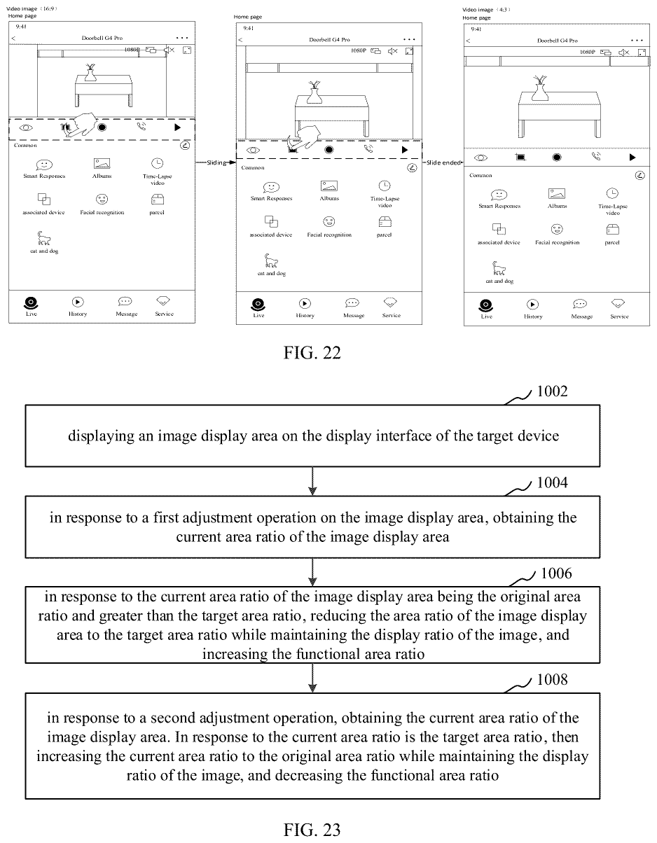

The first return operation, being the reverse of the first adjustment operation, and the second return operation, being the reverse of the second adjustment operation, may be configured to restore the area ratio of the image display area to the original area ratio or to the target area ratio. In response to the first return operation on the image display area, the first return operation may involve the user sliding downwards and/or to the right in the video function bar; this operation may be configured to increase the area ratio of the image display area. For example, as shown in FIG. 22, in response to the current area ratio of the image display area is the area ratio that fills the image display area with a display ratio of 16:9 (target area ratio), then the area ratio of the image display area may be restored from the target area ratio to the original area ratio (such as the area ratio that fills the image display area with a display ratio of 4:3).

In response to the second return operation on the image display area, the second return operation may involve the user sliding upwards and/or to the left in the video function bar; this operation may be configured to decrease the area ratio of the image display area. Conversely, the area ratio of the image display area may be restored from the original area ratio to the target area ratio.

In the method of this embodiment, after adjusting the area ratio of the image display area to the target area ratio, a return operation may also be triggered to restore the area ratio of the image display area from the target area ratio back to the original area ratio, and vice versa, this enhances the flexibility and reversibility of the area ratio adjustment.

In an exemplary embodiment, following the reduction of the current area ratio to the target area ratio as described above, the method may further include:

Performing background filling for the non-image area in the image display area whose area ratio is the target area ratio; the non-image area is the area within the image display area that is outside of the image.

In this embodiment, the adjustment operation may include a first adjustment operation; the first adjustment operation may be configured to reduce the area ratio of the image display area. During this process, the area ratio of the image display area continuously decreases. Specifically, the vertical size of the image display area may become smaller while the horizontal size remains unchanged, and its horizontal size may be consistent with the horizontal size of the display interface. Under the original area ratio, the image fills the entire image display area, with the image's horizontal size matching the horizontal size of the image display area and the image's vertical size matching the vertical size of the image display area. As the area ratio of the image display area is adjusted through the first adjustment operation, the image displayed in the image display area will also shrink as a whole, but the display ratio of the image remains unchanged. Therefore, non-image areas will exist within the image display area, which are the areas outside of the image. In this case, background filling, such as color filling, may be performed on the non-image area, for example, filling the non-image area of the image display area with black.

In the method of this embodiment, during the adjustment of the area ratio of the image display area, color filling may be performed synchronously on the non-image area of the image display area to ensure the harmony of the image.

In an exemplary embodiment, the display interface also displays a functional area, and the method may further include the following steps: Adjusting the functional area ratio of the functional area in response to changes in the area ratio of the image display area; the functional area ratio is configured to indicate the proportion of the functional area in the display interface; the sum of the area ratio of the image display area and the functional area ratio remains unchanged.

The display interface of the application may also display a functional area, and the sum of the area ratio of the image display area and the functional area ratio remains unchanged.

In the method of this embodiment, the area ratio of the image display area on the display interface of the target device may be flexibly adjusted. Consequently, the functional area ratio of the functional area in the same display interface for processing images or videos may also be correspondingly changed. This enhances the flexibility and simplicity of image adjustment. In response to a larger area ratio of the image display area, the area ratio of the image display area may be reduced to increase the functional area ratio of the functional area, facilitating subsequent processing of images or videos and improving the simplicity and efficiency of image processing.

In an exemplary embodiment, the functional area includes function implementation buttons, and the method further comprises the following steps: in response to a selection operation on the function implementation button, displaying function operation information corresponding to the function implementation button in at least one of the image display area and the functional area.

The functional area may include a function bar, which may include at least one function implementation button. Function operation information refers to the relevant information displayed in at least one of the image display area and the functional area after a selection operation is triggered on the function implementation button. The at least one function implementation button may include commonly used functions of the application, such as the Live button, History button, Message button, Service button, etc. The Live button may contain at least one real-time operation function button, such as Smart Responses, Albums, Time-Lapse Video, associated device, Facial recognition, parcel, and cat and dog. The at least one real-time operation function button may be configured to adjust the capture operation of the capture device (camera) and to adjust and process the image displayed in the image display area. As shown in FIG. 3, triggering the Live button may display the at least one real-time operation function button (a type of function operation information) in the functional area of the display interface, and may display the real-time captured image from the capture device (a type of function operation information) in the image display area of the display interface. As shown in FIG. 4, triggering the History button may display the spatial status information of the target space in the functional area in the form of a timeline for a historical time period (a type of function operation information), such as human activity information (e.g., baby crying detected at 23:30:00, activity in the living room detected at 21:41:00), and may display the captured image of the capture device during the historical time period in the image display area (a type of function operation information).

In the method of this embodiment, the display interface of the application may include function implementation buttons, facilitating multi-functional operations for image capture and processing, thereby enhancing the simplicity and efficiency of image processing.

In another exemplary embodiment, as shown in FIG. 23, an image processing method is provided, which may include:
Step 1002: displaying an image display area on the display interface of the target device. The image display area is configured to display images from the capture device.

The display interface of the application is divided into two core areas: the “video image area,” which is the image display area, and the “function area,” which is the functional area. The display interface may show the image display area, which is configured to display images from the capture device (e.g., a camera). These images may include at least one of real-time still images and videos captured by the camera, such as a view of the living room. Additionally, the display interface of the application may also display the functional area. The sum of the area ratio of the image display area and the functional area ratio remains constant.
Step 1004: in response to a first adjustment operation on the image display area, obtaining the current area ratio of the image display area.

The display ratio of the image in the image display area varies according to the device type of different capture devices (16: 9, 4:3, 1:1); (1) This ratio is determined by the camera, with each device having a fixed ratio; (2) The video ratio is uploaded to the cloud along with the video content, and the app only reads and displays this data from the cloud without altering its true ratio; (3) Currently, mainstream cameras only support 16:9, 1:1, and 4:3. Users may enlarge or reduce the area ratio of the image display area by “swiping,” as shown in FIG. 19A and FIG. 19B. Users may trigger an adjustment operation by swiping up, down, left, or right in the video function bar. When the original area ratio of the image display area is the target area ratio (e.g., the area ratio that fills the image display area with a display ratio of 16:9), the image remains fixed and unchanged.
Step 1006: in response to the current area ratio of the image display area being the original area ratio and greater than the target area ratio, reducing the area ratio of the image display area to the target area ratio while maintaining the display ratio of the image, and increasing the functional area ratio.

When the original area ratio is not the target area ratio that fills the image display area with a display ratio of 16:9, as shown in FIG. 21A and FIG. 21B, users may hold the “video function bar” and swipe upwards to reduce the area ratio of the image display area to the target area ratio. During the reduction to the target area ratio, the non-image area in the image display area, which does not contain the image, may be automatically filled with black. After reducing the area ratio of the image display area to the target area ratio, the image no longer changes automatically. In response to users release their hold during the swipe, the area ratio of the image display area may automatically become the target area ratio.
Step 1008: in response to a second adjustment operation, obtaining the current area ratio of the image display area. In response to the current area ratio is the target area ratio, then increasing the current area ratio to the original area ratio while maintaining the display ratio of the image, and decreasing the functional area ratio.

As shown in FIG. 22, users may swipe downwards in the video function bar (second adjustment operation or first return operation) to restore the area ratio of the image display area from the target area ratio to the original area ratio, with the functional area ratio correspondingly decreasing.

In the method provided by this embodiment of the present disclosure, the area ratio of the image display area on the display interface of the target device may be flexibly adjusted. Correspondingly, the functional area ratio of the functional area in the same display interface for processing images or videos may also be changed. This enhances the flexibility and simplicity of image adjustment. In response to a larger area ratio of the image display area, the area ratio of the image display area may be reduced to increase the functional area ratio, facilitating subsequent processing of images or videos and improving the simplicity and efficiency of image processing.

### Exemplary Method

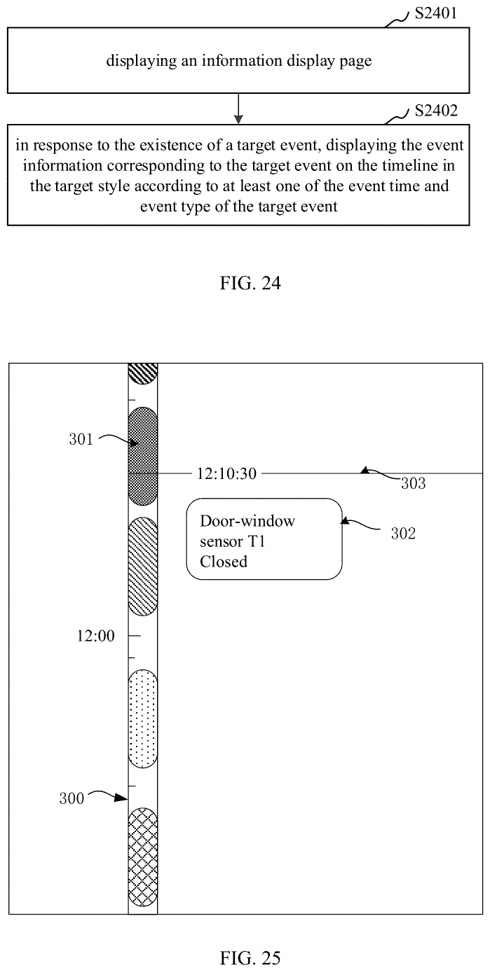

In an exemplary embodiment, as shown in FIG. 24, an information display method is provided, which is illustrated by being applied to the user terminal in FIG. 1. The method may include the following steps:
Step S2401: displaying an information display page, the information display page may include an event timeline corresponding to the monitoring data; the monitoring data may include surveillance data obtained by at least one of the camera device and the associated device; the associated device is a device associated with the camera device.

The information display page may be the information display page of the camera device, which may be configured to display information related to the camera device. This related information may include at least one of the information of the camera device itself and the information of the associated device. The associated device refers to a device that is associated with the camera device. The number of camera devices may include one or more, and the number of associated devices may also include one or more. As an embodiment, the information display page may display information of one or more camera devices and may also display information of one or more associated devices associated with the one or more camera devices.

The camera device may be a camera or a smart device with camera functionality. For example, a camera may serve as the camera device, and a smart door lock with camera functionality may also serve as the camera device.

The associated device, which is associated with the camera device, may be a smart device with monitoring functions for humans, animals, plants, the environment, space, etc., and may include cameras or smart devices with camera functionality. For example, the associated device may include cameras, radars, smart door locks, door and window sensors, smart lights, and other smart devices.

The monitoring data may be data obtained by monitoring one or more target objects through one or more smart devices and monitoring methods. The monitoring data may include surveillance data obtained by at least one of the camera device and the associated device. At least one of the camera device and the associated device may monitor the target object in real-time to obtain monitoring data. The data type of the monitoring data may include various types, such as numerical monitoring data, image-based monitoring data, text-based monitoring data, audio-based monitoring data, etc. For example, a camera may capture images containing humans as monitoring data, and the event of a human being present in a space captured by the camera may also serve as monitoring data; a smart door lock may monitor the event of someone lingering at the door as monitoring data, and the image of someone lingering at the door captured by the smart door lock may also serve as monitoring data.

The event timeline may be a tool or chart that visualizes the monitoring data based on time, displaying the data in the order of occurrence or time progression. The event timeline may include time scales to divide and identify different time points or time periods, which may be different time units such as years, months, days, hours, etc., set according to specific needs. For example, the event timeline may be a linear timeline, which presents time in a linear form, with events arranged in chronological order from left to right or from top to bottom, suitable for displaying monitoring data with a clear temporal sequence.

The information display page may include an event timeline corresponding to the monitoring data, which may be configured to display information related to the monitoring data. In implementation, the event timeline may be displayed and viewed on a certain time cycle basis (such as one day).

In this step, the information display page may display information related to the monitoring data obtained by at least one of the camera device and the associated device through the event timeline. Therefore, users may understand the monitoring information related to at least one of the camera device and the associated device through this information display page, thereby improving the efficiency of information display.
Step S2402: in response to the existence of a target event, displaying the event information corresponding to the target event on the timeline in the target style according to at least one of the event time and event type of the target event. The target event may be identified based on the recognition of the monitoring data.

The event information may include event identifiers and event label information. A target event may be a specific event that is predefined and needs to be monitored or responded to in a particular context or system. For example, in a security monitoring context, a target event may be a specific abnormality or dangerous situation that needs to be monitored and prevented, such as illegal intrusion, fire, or abnormal behavior. Various sensors and monitoring devices may be used in a smart home security system to obtain real-time monitoring data from the home, which may then be configured to monitor the target events.

In this embodiment, the target event may be identified based on the recognition of the monitoring data obtained by at least one of the camera device and the associated device. As an example, the target event may include identification based on the monitoring data obtained by the camera device; it may also include identification based on the monitoring data obtained by the associated device; or it may include identification based on the monitoring data obtained by both the camera device and the associated device. The target event may be the same event monitored by both the camera device and the associated device, or it may be different events monitored by the camera device and the associated device.

The event time of the target event may include the start time and end time of the event. As an example, the event time may be identified based on the recognition of the monitoring data.

The event type of the target event refers to the category of the event. Multiple event types may be set, and the target event and its event type may be identified based on the recognition of the monitoring data.

The target style refers to the style of display on the timeline, which may be one or more of the set styles.

The event identifier corresponding to the target event may be a graphic pattern or other identifier configured to represent the target event on the timeline.

The event information corresponding to the target event may be the relevant information associated with the target event. As an example, the event information may include event identifiers, event label information, event time, event type, event summary, etc., and this embodiment does not limit the scope of the event information.

In this step, the recognition of the monitoring data may be configured to determine whether a target event exists. In response to the existence of a target event, the event identifier and event label information corresponding to the target event may be displayed on the timeline in the target style according to at least one of the event time and event type of the target event. Different events' event identifiers and event label information may be displayed on the timeline in different styles, allowing users to quickly and intuitively browse and locate the target event and understand its related information through the timeline.

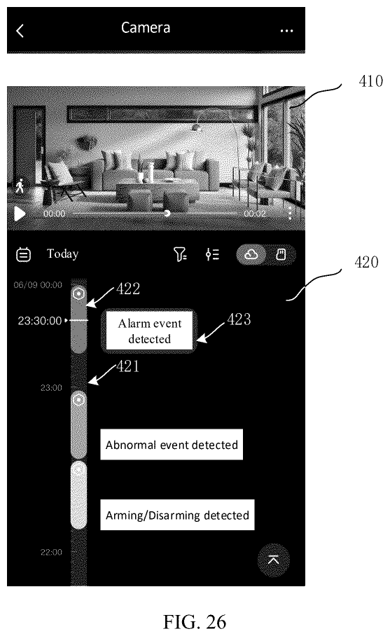

As an example, FIG. 25 shows a schematic diagram of a timeline, where the event identifier 301 corresponding to the target event and the event label information 302 corresponding to the target event may be displayed on the timeline 300 in the target style according to at least one of the event time and event type of the target event. The event label information 302 may be the event label information corresponding to the event identifier 301 that occurred at 12:10:30, such as “Door and window sensor T1 closed.”

The information display method of this embodiment displays an information display page, which includes a timeline corresponding to the monitoring data. The monitoring data includes surveillance data obtained by at least one of the camera device and the associated device. The associated device is a device associated with the camera device. In response to the existence of a target event, the event identifier and event label information corresponding to the target event are displayed on the timeline in the target style according to at least one of the event time and event type of the target event. The target event is identified based on the recognition of the monitoring data. This solution may display the timeline corresponding to the monitoring data obtained by at least one of the camera device and the associated device on the information display page. It may display the event identifier and event label information corresponding to the target event on the timeline in the target style according to at least one of the event time and event type of the target event obtained by recognizing the monitoring data. Users may view the information of the target event on the timeline without multiple operations, thereby improving the efficiency of displaying event information on the timeline of the information display page.

In an exemplary embodiment, displaying the event identifier and event label information corresponding to the target event on the timeline in the target style according to at least one of the event time and event type of the target event in step S2402 may include:
displaying the event identifier corresponding to the target event on the timeline in the target style according to at least one of the event time and event type of the target event; displaying the event label information corresponding to the target event based on the display position of the event identifier, and displaying at least one of a thumbnail of the video clip corresponding to the target event and a display entry for the video clip.

In this embodiment, the event identifier corresponding to the target event may first be displayed on the timeline in the target style according to at least one of the event time and event type of the target event. The event identifier may be displayed in the target color on the timeline according to the start time and end time of the target event.

The display position of the event identifier refers to the position of the event identifier on the timeline, which allows for quick localization of the corresponding target event on the timeline through the event identifier.

The event information corresponding to the target event may be information related to the target event, such as descriptive information about the target event. The event information may include the event identifier, event label information, event name, occurrence time, location/position of the target event, etc.

Therefore, based on the display position of the event identifier, the event information corresponding to the target event may be displayed. For example, the event information corresponding to the target event may be displayed at a position on one side of the timeline corresponding to the display position of the event identifier, allowing users to quickly locate the corresponding target event on the timeline through the event identifier and understand the event information corresponding to the target event.

The video clip corresponding to the target event may be a video clip of the target event recorded by at least one of the camera device and the associated device. The video clip may be a segment of video with a certain duration that includes multiple consecutive video frames. The duration may vary depending on the duration of the target event. The longer the duration of the target event, the longer the duration of the video clip may be. Alternatively, a fixed duration may be used. The duration of the video clip may be several seconds, several minutes, or longer. As an example, at least one of the camera device and the associated device may monitor whether the monitoring image contains a target object. In response to detecting the target object (target event) in the monitoring image, video clip recording may be initiated. A video clip of a fixed duration may be recorded, or recording may be stopped when the target object is no longer detected in the monitoring image, resulting in a video clip corresponding to the target event.

The thumbnail may include one or more thumbnails corresponding to the video clip of the target event, which may be configured to represent the video clip of the target event in image form. One or more video images may be extracted from the video clip to serve as thumbnails.

The display entry refers to the display entry for the video clip corresponding to the target event, which may be configured to trigger the display of the video clip.

Therefore, based on the display position of the event identifier, the event information corresponding to the target event, as well as at least one of the thumbnail and display entry of the video clip corresponding to the target event, may be displayed. For example, the event information corresponding to the target event, as well as at least one of the thumbnail and display entry, may be displayed at a position on one side of the timeline corresponding to the display position of the event identifier.

The solution of this embodiment may facilitate users to quickly locate the corresponding target event on the timeline through the event identifier and understand the event information corresponding to the target event, as well as at least one of the thumbnail and display entry of the video clip. This enhances the efficiency of information display and the convenience of operations when users need to view the video clip.

In an exemplary embodiment, following the display of the event information corresponding to the target event based on the display position of the event identifier as described above, the method of this disclosure may further include:

In response to a triggering operation on the event information, displaying at least one of the event details and the video clip corresponding to the target event.

In this embodiment, as shown in FIG. 25, the event information 302 may be displayed in the form of text content or a text box containing text content on one side of the timeline 300, allowing users to view at least one of the event details and the video clip corresponding to the target event through a triggering operation on the event information 302.

The triggering operation on the event information may include operations such as a click, double-click, or long press triggered on the event information. The event details refer to the detailed information corresponding to the target event, which may include information such as the start time, end time, event type, and occurrence frequency of the target event.

In this embodiment, by triggering operations such as a click, double-click, or long press on the event information, users may be presented with at least one of the event details and the video clip corresponding to the target event. This enriches the style and triggering methods for displaying information related to the target event on the information display page, thereby improving the efficiency of information display.

In an exemplary embodiment, following the display of the event identifier corresponding to the target event on the timeline in the target style according to at least one of the event time and event type of the target event as described above, the method may further include:

Displaying at least one of the event start time and event end time corresponding to the target event based on the display position of the event identifier.

The event start time corresponding to the target event refers to the time when the target event occurs, and the event end time corresponding to the target event refers to the time when the target event ends.

In this embodiment, based on the display position of the event identifier, at least one of the event start time and event end time corresponding to the target event may be displayed. For example, the event start time and event end time of the target event may be displayed at a position on one side of the timeline corresponding to the display position of the event identifier. This allows users to quickly locate the corresponding target event on the timeline through the event identifier and understand at least one of the event start time and event end time corresponding to the target event.

In an exemplary embodiment, the number of camera devices includes multiple devices; displaying the event information corresponding to the target event on the timeline in the target style according to at least one of the event time and event type of the target event in step S2402 may include:
displaying the event information corresponding to the target event of each camera device on the timeline in the target style according to at least one of the event time and event type of each camera device.

In this embodiment, different camera devices may use different target styles to display the event information corresponding to the target event. For example, different colors/patterns of event identifiers may be configured to represent the target events of different camera devices. For instance, one or more colors may be set for each camera device, with different colors set for different camera devices, thereby allowing the target events of different camera devices to be visually distinguished on the same timeline. This may intuitively identify the camera device to which the target event belongs on the timeline, facilitating users to quickly locate the target event of the camera device they need to view.

In this embodiment, different camera devices may also use the same target style to display the event information corresponding to the target event, while different target events may use different target styles to display the event information. This may intuitively identify different target events on the timeline, facilitating users to quickly locate the target event they need to view.

In an exemplary embodiment, prior to displaying the event information corresponding to the target event on the timeline in the target style according to at least one of the event time and event type of the target event in step S2402, the method may further include:

In response to the associated device detecting the target event, controlling the camera device associated with the associated device to monitor the occurrence location of the target event to obtain monitoring data.

The occurrence location refers to the location where the associated device detects the target event. The occurrence location may be determined as the position where the associated device that detects the target event is installed in space. The installation position refers to the location in space where the associated device is installed. For example, in response to the associated device that detects the target event is installed in the living room, kitchen, or bedroom, then the living room, kitchen, or bedroom may be considered as the occurrence location of the target event. Alternatively, the occurrence location may be the position in space where the associated device detects the target event. For example, if the associated device detects a target event such as the presence of a person at the entrance or balcony, then the entrance or balcony may be considered as the occurrence location.

In this embodiment, the associated device may detect the target event and then send a monitoring command to the camera device. The camera device may determine the occurrence location of the target event based on the monitoring command. As an example, the associated device may include the occurrence location in the monitoring command, such as sending the location of the associated device in the monitoring command to the camera device. In this way, the camera device may determine the occurrence location based on the monitoring command. Consequently, the camera device may monitor the occurrence location of the target event, for example, by recording video at the occurrence location to obtain monitoring data.

For example, taking a camera as the camera device and a human body sensor as the associated device, the associated device may be installed on the balcony. The target event may include the detection of a person. Therefore, in response to the human body sensor detecting a person, the balcony is the occurrence location of the target event. The human body sensor may include the occurrence location in the monitoring command and send this command to the camera. The camera may determine the occurrence location based on the monitoring command and then turn the monitoring view towards the balcony. After turning towards the balcony, the camera may record video at the occurrence location of the target event, and the recorded video data may serve as the monitoring data.

The solution of this embodiment may monitor target events occurring within a target space, such as an entire house, through the coordination of associated devices and camera devices, thereby improving monitoring efficiency and consequently enhancing the efficiency of information display on the information display page.

In an exemplary embodiment, the information display page may include an image playback area and a monitoring record area; the image playback area is configured to play real-time images captured by the camera device and video clips corresponding to target events; the response to the existence of a target event in step S2402, displaying the event identifier and label event information corresponding to the target event on the timeline in the target style according to at least one of the event time and event type of the target event, includes: in response to the existence of a target event, displaying the event identifier and label event information corresponding to the target event on the timeline in the target style according to at least one of the event time and event type of the target event in the monitoring record area.

The above method also includes: in response to a triggering operation on a selected event identifier, playing the video clip corresponding to the selected event identifier in the image playback area.

As shown in FIG. 26, the information display page may include an image playback area 410 and a monitoring record area 420. The image playback area 410 may be configured to play real-time images captured by the camera device and video clips corresponding to target events. The monitoring record area 420 may be configured to record relevant monitoring information from at least one of the camera device and the associated device. The monitoring record area 420 may be configured to display the timeline 421. The timeline 421 may display the event identifier 422 corresponding to the target event, and the event label information 423 corresponding to the target event may be displayed on one side of the timeline 421 in the form of a text box containing text content or other controls, according to the position of the event identifier 422 on the timeline 421.

In this embodiment, in response to the existence of a target event, the event identifier 422 and event label information 423 corresponding to the target event may be displayed on the timeline 421 in the monitoring record area 420 in the target style according to at least one of the event time and event type of the target event. In this regard, users may trigger operations such as a click, double-click, or long press on a certain event identifier 422 displayed on the timeline 421 in the monitoring record area 420. The terminal may respond to the triggering operation on the selected event identifier 422 by playing the video clip corresponding to the selected event identifier 422 in the image playback area 410. As an example, taking an alarm event as the target event, the event identifier 422 of the alarm event may be displayed on the timeline 421 according to the occurrence time of the alarm event. Users may trigger operations such as a click, double-click, or long press on the event identifier 422 of the alarm event on the timeline 421, and the terminal may play the video clip corresponding to the alarm event in the image playback area 410.

The solution of this embodiment facilitates users to locate and view the video clips of target events through the image playback area and monitoring record area on the information display page.

In an exemplary embodiment, the information display page may include an image playback area and a monitoring record area; the image playback area may include multiple sub-image playback areas corresponding to multiple camera devices; each sub-image playback area may be configured to play real-time images captured by the respective camera devices and video clips corresponding to target events monitored by the respective camera devices. The response to the existence of a target event in step S202, displaying the event identifier and event label information corresponding to the target event on the timeline in the target style according to at least one of the event time and event type of the target event, includes: in response to the existence of a target event, displaying the event identifier and event information corresponding to the target event on the timeline in the target style in the monitoring record area according to at least one of the event time and event type of the target event.

The above method also includes: in response to a triggering operation on a selected event identifier, playing the video clip corresponding to the selected event identifier in the sub-image playback area corresponding to the target device where the target event was detected.

The multiple camera devices may include different cameras or smart devices with camera functionality. These camera devices may be installed in different locations within the space, or they may all be installed in the same location within the space, or some may be installed in the same/different locations within the space. For example, the multiple camera devices may include Camera 1 to Camera 4, where Camera 1 may be installed in the living room, Camera 2 in the kitchen, Camera 3 in Bedroom 1, and Camera 4 in Bedroom 2.

The sub-image playback area refers to each sub-image playback area, which may be a part of the image playback area. The image playback area may be divided into multiple sub-image playback areas of equal or different sizes. The number of sub-image playback areas may be determined based on the number of camera devices. One sub-image playback area may correspond to one camera device, and may be configured to display the video clips corresponding to the target events monitored by the respective camera device and the real-time images captured by it. For example, in response to there are multiple camera devices including Camera 1 to Camera 4, the image playback area may be divided into four sub-image playback areas, corresponding to Camera 1 to Camera 4, respectively. These may be configured to display the video clips corresponding to the target events monitored by Camera 1 to Camera 4 and the real-time images captured by them.

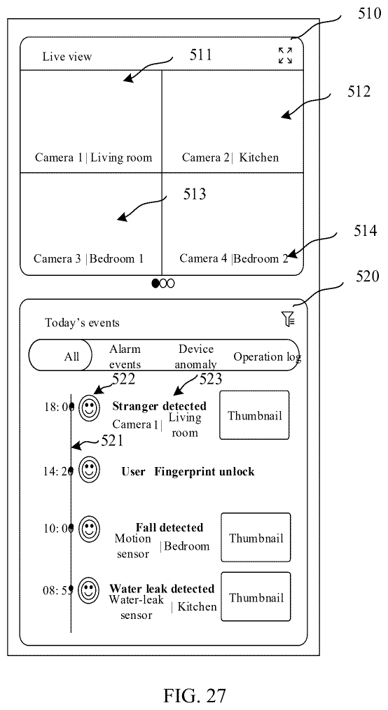

As shown in FIG. 27, the information display page may include an image playback area 510 and a monitoring record area 520. The image playback area 510 may include multiple sub-image playback areas corresponding to multiple camera devices, such as the sub-image playback area 511 for Camera 1, the sub-image playback area 512 for Camera 2, the sub-image playback area 513 for Camera 3, and the sub-image playback area 514 for Camera 4. Each sub-image playback area may be configured to play the real-time images captured by the respective camera device and the video clips corresponding to the target events monitored by it. For example, the sub-image playback area 511 may be configured to play the real-time images captured by Camera 1 and the video clips corresponding to the target events monitored by it; the sub-image playback area 512 may be configured to play the real-time images captured by Camera 2 and the video clips corresponding to the target events monitored by it; the sub-image playback area 513 may be configured to play the real-time images captured by Camera 3 and the video clips corresponding to the target events monitored by it; the sub-image playback area 514 may be configured to play the real-time images captured by Camera 4 and the video clips corresponding to the target events monitored by it, and so on. In this way, the relevant monitoring information of multiple camera devices may be viewed on this information display page. The monitoring record area may be configured to record the relevant monitoring information of each camera device and its associated devices. The monitoring record area may display a timeline, on which the relevant monitoring information of each camera device and its associated devices may be displayed.

In this embodiment, in response to the existence of a target event, the event identifier 522 and event label information 523 corresponding to the target event may be displayed on the timeline 521 in the monitoring record area 520 in the target style according to at least one of the event time and event type of the target event. The event identifier 522 and event label information 523 corresponding to the target events of each camera device and its associated devices may be displayed. In this regard, users may trigger operations such as a click, double-click, or long press on a certain event identifier 522 displayed on the timeline 521 in the monitoring record area 520. The terminal may respond to the triggering operation on the selected event identifier 522 by playing the video clip corresponding to the selected event identifier in the sub-image playback area corresponding to the camera device that detected the target event in the image playback area 510. For example, a click operation may be triggered on the event identifier 522 for detecting a stranger, and the terminal may play the video clip corresponding to the event in the sub-image playback area 511 corresponding to Camera 1 in the image playback area 510.

The solution of this embodiment facilitates users to locate and view the video clips of target events through the image playback area and monitoring record area on the information display page, and it is suitable for scenarios involving multiple camera devices.

In an exemplary embodiment, the method of this disclosure may further include:

after playing the video clip corresponding to the selected event identifier in the image playback area, playing the video clips corresponding to the event identifiers on the timeline in the order of event time. The target events may be displayed on the timeline as event identifiers according to the event time. Multiple target events'event identifiers may be displayed on the timeline, and these event identifiers are arranged on the timeline in the order of the event time of the target events. Users may trigger operations such as a click, double-click, or long press on a certain event identifier displayed on the timeline to select that event identifier. After the image playback area plays the video clip corresponding to the selected event identifier, it may continue to play the video clip corresponding to the next event identifier. The next event identifier refers to the event identifier that is determined based on the selected event identifier, following the order of the event time of the target events. This process continues to play the video clips corresponding to the event identifiers on the timeline in sequence.

As shown in FIG. 26 and FIG. 27, the terminal may play the video clip corresponding to the selected event identifier (422 or 522) in the sub-image playback area (511 to 514) of the image playback area 410 or 510. After playing, the terminal may continue to play the video clip corresponding to the next event identifier of the selected event identifier.

Taking FIG. 26 as an example, users may select the event identifier 422 corresponding to “Detecting an abnormal event.” The terminal may play the video clip corresponding to the event identifier 422 for “Detecting an abnormal event” in the image playback area 410. After playing, the terminal may play the video clips corresponding to the event identifiers 422 on the timeline 421 in the order of event time. The order of event time may include chronological order and reverse chronological order. Chronological order refers to the direction of the natural flow of time, that is, from the past to the present and then to the future. Reverse chronological order is the opposite of chronological order, that is, from the future to the present and then to the past. Therefore, the terminal may play the video clips corresponding to the event identifiers 422 on the timeline 421 in chronological order or reverse chronological order. For example, after playing the video clip corresponding to the event identifier 422 for “Detecting an abnormal event,” the terminal may play the video clip corresponding to the next event identifier 422 on the timeline 421 in chronological order (i.e., the event identifier 422 for “Detecting an alarm event”). Alternatively, after playing the video clip corresponding to the event identifier 422 for “Detecting an abnormal event,” the terminal may play the video clip corresponding to the next event identifier 422 on the timeline 421 in reverse chronological order (i.e., the event identifier 422 for “Detecting arming/disarming”). This achieves the effect of continuous playback of event video clips, thereby skipping the timeline segments that do not have video clips, improving the convenience of operation and the efficiency of information display.

In an exemplary embodiment, the method of this disclosure may further include: obtaining the operation trajectory for each event identifier on the timeline, and playing the video clip corresponding to the event identifier targeted by the operation trajectory in the image playback area based on the operation trajectory.

The operation trajectory may be configured to select event identifiers on the timeline. Users may trigger an operation trajectory for each event identifier on the timeline by swiping the timeline to select the event identifiers. Through the operation trajectory, one or more event identifiers may be selected in sequence for the playback of their corresponding video clips. Users may trigger an operation trajectory for each event identifier on the timeline by swiping the timeline to select one or more event identifiers in sequence, and then play the video clips corresponding to the selected one or more event identifiers in the image playback area.

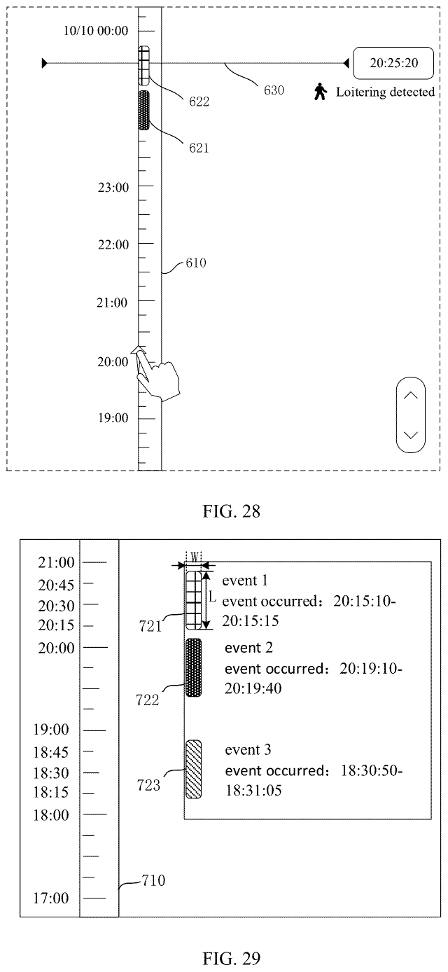

In this embodiment, as shown in FIG. 28, users may trigger an operation trajectory for each event identifier (including but not limited to event identifiers 621 and 622) on the timeline 610 in the monitoring record area of the information display page. The monitoring record area may also include a timeline 630, which may be configured to indicate the selected time point on the timeline 610. The timeline 630 may be set to intersect with the timeline 610 to indicate the intersecting time point. Therefore, by swiping the timeline 610 to intersect with the timeline 630 at different time points, different time points may be selected. The event identifiers (621 and 622, etc.) are set on the timeline 610. By swiping the timeline 610 to trigger the intersection of the event identifiers 621 and 622 with the timeline 630 (i.e., the operation trajectory), the event identifiers 621 and 622 targeted by the operation trajectory may be selected in sequence. Subsequently, the video clips corresponding to the event identifiers 621 and 622 targeted by the operation trajectory may be played in sequence in the image playback area. This enriches the triggering operations for playing video clips corresponding to event identifiers in the image playback area, thereby improving the convenience of operation.

In an exemplary embodiment, the target style may include the target size of the event identifier, where the target size of different event identifiers is the same; the target style may also include the target color of the event identifier, where the target color of event identifiers corresponding to different event types is different.

The target size of the event identifier refers to the size of the event identifier when displayed on the timeline, which may include the length and width displayed on the timeline.

The target color of the event identifier refers to the color of the event identifier when displayed on the timeline, which may be red, green, etc.

In this embodiment, different target events may have different event types, and the target color of event identifiers corresponding to different event types may be different, while the target size of different event identifiers may be the same. Therefore, the terminal may display the event identifier of the target event on the timeline with the corresponding target color and target size based on the event type of the target event.

In this embodiment, as shown in FIG. 29, different event types correspond to different target colors of event identifiers (indicated by different stripes in the FIG.). Events 1 to 3 may belong to different event types, respectively. Event 1 corresponds to event identifier 721, Event 2 corresponds to event identifier 722, and Event 3 corresponds to event identifier 723. Event identifiers 721, 722, and 723 may have different target colors (indicated by different stripes in the FIG.), while the target size of different event identifiers may be the same. The target size may include length L and width W, and event identifiers 721, 722, and 723 may have the same length L and width W. Therefore, event identifiers (event identifiers 721, 722, and 723) may be represented on the timeline 710 with the same target size, and different event types' event identifiers may be distinguished by different colors. This ensures that each event is not easily overlooked or requires sliding through a long duration to transition to the next event for viewing. It helps users quickly locate target events of different event types, thereby enhancing the effectiveness of information display.

In an exemplary embodiment, the timeline also includes timeline segments where no target events exist; the duration ratio corresponding to the segment size of the timeline segment is greater than the duration ratio corresponding to the target size; the segment size is the size of the timeline segment on the timeline.

A timeline segment refers to a particular segment on the timeline. The timeline segment where no target events exist is configured to indicate that no target events occurred during the time corresponding to this timeline segment.

The segment size of the timeline segment refers to the size of the timeline segment on the timeline.

The duration ratio corresponding to the size refers to the duration ratio that the size corresponds to on the timeline.

In this embodiment, the event identifiers of target events may be displayed on the timeline, and the timeline segments where no target events exist may also be displayed on the timeline. These timeline segments may be configured to indicate that no target events occurred during the time corresponding to these segments.

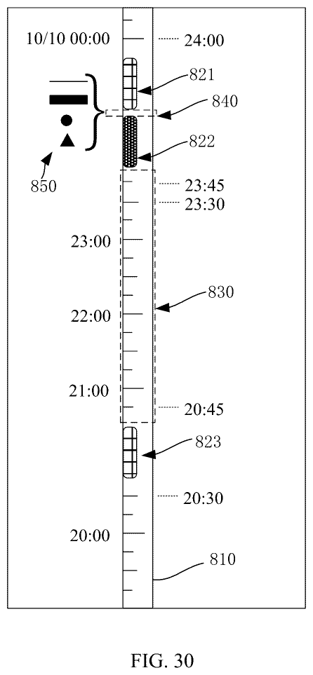

As shown in FIG. 30, in this embodiment, the duration ratio corresponding to the segment size of the timeline segment 830 is greater than the duration ratio corresponding to the target size. That is, under the same size, the duration represented by the timeline segment 830 where no target events exist is longer than the duration represented by the event identifiers (including but not limited to event identifiers 821, 822, and 823). Therefore, this embodiment's solution may use a larger duration ratio for the timeline segment 830 where no target events exist on the timeline 810. This allows a larger blank period to be included within a smaller timeline length, thereby compressing the representation space for times where no target events exist on the timeline 810. This enables more relevant monitoring information for target events to be displayed on the limited screen page size, improving the efficiency of information display.

In an exemplary embodiment, displaying the information display page in step S201 includes:

Obtaining the duration corresponding to the timeline segment to be displayed; in response to the duration being a unit duration, obtaining the segment size of the timeline segment as the unit segment size corresponding to the unit duration; the unit duration and the unit segment size indicate a duration ratio; in response to the duration not reaching the unit duration, obtaining the segment size of the timeline segment based on the duration ratio and the unit segment size; displaying the timeline containing the timeline segment on the information display page according to the segment size.

The duration corresponding to the timeline segment to be displayed refers to the duration of the timeline segment where no target events exist, that is, how long the timeline segment where no target events exist has lasted.

The unit duration may be a pre-set unit duration, such as 1 hour.

The unit segment size refers to the segment size corresponding to the unit duration. This unit segment size may be a pre-set unit length on the timeline corresponding to the unit duration. The unit duration and the unit segment size indicate a duration ratio, which may be configured to represent how much size a unit duration (such as 1 hour) corresponds to on the timeline. The duration ratio refers to the ratio of the duration corresponding to the timeline segment to be displayed to the above-mentioned unit duration. Therefore, the segment size of the timeline segment may be obtained by the product of the duration ratio and the unit segment size.

In this embodiment, in response to the duration corresponding to the timeline segment to be displayed is the unit duration, such as reaching 1 hour, the terminal may obtain the unit segment size corresponding to the unit duration as the segment size of the timeline segment to be displayed. Therefore, the unit duration and its unit segment size may be pre-set. For the case where the duration corresponding to the timeline segment to be displayed reaches the unit duration, the segment size of the timeline segment may be determined as the unit segment size corresponding to the unit duration. In response to the duration corresponding to the timeline segment to be displayed not reaching the unit duration, such as not reaching 1 hour, the terminal may obtain the segment size of the timeline segment based on the product of the duration ratio and the unit segment size.

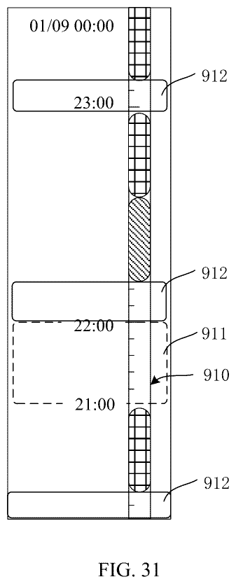

As shown in FIG. 31, in this embodiment, in response to the duration corresponding to the timeline segment to be displayed being the unit duration of 1 hour, the terminal may obtain the unit segment size corresponding to the unit duration as the segment size of the timeline segment to be displayed, thereby displaying the timeline segment 911 on the timeline 910. In response to the duration corresponding to the timeline segment to be displayed not reaching the unit duration of 1 hour, the terminal may obtain the segment size of the timeline segment based on the product of the duration ratio and the unit segment size, thereby displaying the timeline segment 912 on the timeline 910.

As shown in FIG. 31, after obtaining the segment size of the timeline segment to be displayed, the timeline 910 containing the timeline segments (911 and 912) where no target events exist may be displayed on the information display page. This enhances the richness of the information displayed on the information display page while ensuring the display effect of the event identifiers of target events on the timeline.

In an exemplary embodiment, the method of this disclosure may further include:

Displaying the timeline segments where no target events exist on the timeline in a preset style. The preset style includes at least one of compressing the timeline segments where no target events exist into a preset-size blank timeline segment and displaying the timeline segments where no target events exist as a preset-shape indicator.

The preset style may be a style configured to display the timeline segments where no target events exist on the timeline.

In this embodiment, the preset style may include at least one of compressing the timeline segments where no target events exist into a preset-size blank timeline segment and displaying the timeline segments where no target events exist as a preset-shape indicator.

The preset-size blank timeline segment may be a timeline segment of a preset size that does not contain event identifiers, that is, it may be a timeline segment corresponding to a time period where no target events occurred. The preset size may be set according to needs and may be a fixed size.

As shown in FIG. 30, the timeline segment 840 where no target events exist may be displayed on the timeline 810 in a preset style that compresses the timeline segment into a preset-size blank timeline segment. This may compress the display space of the timeline segment where no target events exist on the timeline 810. The preset shape may include shapes configured to compress its display space on the timeline, such as lines. As an example, as shown in FIG. 8, the timeline segment 850 where no target events exist may be displayed on the timeline 810 in a preset style that displays the timeline segment as a preset-shape indicator. The 850 indicates various preset-shape indicators that may be used, such as lines, rectangles, circles, triangles, etc., to mark the timeline segment where no target events exist on the timeline 810 with as little space as possible.

This embodiment's solution may compress the display space of the timeline segment where no target events exist on the timeline in one or more ways, highlighting the display effect of the event identifiers of target events.

As an embodiment, the method of this disclosure may be applied to surveillance systems that require viewing and managing camera recordings, suitable for home security, commercial monitoring, public safety, and other fields. Users may quickly browse and locate interesting video events through the timeline, thereby improving monitoring efficiency. In this regard, the timeline display of camera recordings is generally linearly arranged. The proportion of the timeline and the proportion of the recording time of the target event on the timeline are fixed. The length of the recording determines the length of the event identifier of the target event on the timeline. If the length of the recording is too long and the proportion of the timeline is too small, the event identifier will cover a large range on the timeline. In response to users want to check other target events, they need to swipe through this range, making it difficult to quickly search and check. In response to the length of the recording is too short and the proportion of the timeline is too large, the event identifier of the target event on the timeline may only have a length of a few pixels. Users are very likely to ignore it because they don't notice it, and this very short target event may be very important. In addition, the proportion of time periods without target events on the timeline is very large. These time periods have no target events and are unnecessary to display. Users often need to swipe through a long blank time period to locate a time period with target events, which seriously affects the interaction experience. In addition, the event identifier on the timeline cannot reflect the attributes of the target event.

In this embodiment, the timeline corresponding to the monitoring data obtained by at least one of the camera device and the associated device may be displayed on the information display page. For target events of different time lengths, event identifiers of equal length may be displayed on the timeline. The event identifiers and blank time periods on the timeline may use different time proportions and may be distinguished in various styles to facilitate users in viewing the information of target events and improve the efficiency of displaying event information on the timeline of the information display page.

In this embodiment, the information display page includes a timeline corresponding to the monitoring data. The monitoring data includes surveillance data obtained by at least one of the camera device and the associated device. In response to the existence of a target event, the event identifier and event label information corresponding to the target event are displayed on the timeline in the target style according to at least one of the event time and event type of the target event. As shown in FIG. 25, the timeline 300 may display video event bars (event identifiers 301) distinguished by different colors. The heights of the video event bars may be the same, and there may be blank segments (timeline segments) with time scales between the video event bars, which may be configured to represent areas without video events. The time may also be marked on the left side of the whole point on the timeline. In this way, a continuous overall timeline may be composed. The top timeline 303 may be configured to indicate the current time point of the timeline 300. In response to there is a video event (target event) covering the current time point, the event label information 302 of the video event (target event) may be displayed below the timeline.

In this embodiment, the target style may include the target size of the event identifier, where the target size of different event identifiers is the same. The target style may also include the target color of the event identifier, where the target color of event identifiers corresponding to different event types is different. As shown in FIG. 29 and FIG. 30, regardless of the length of the video event (target event), it may be displayed as an equal-length event bar (event identifiers 721, 722, 723, 821, 822, 823, etc.) on the timeline (710, 810). This may avoid the problem of short video events being not obvious on the timeline and long video events occupying too much space. The blank segments without events on the timeline may use a larger time proportion, which may include a large blank period of time with a very small timeline length, reducing the space occupied by blank time periods on the timeline and improving the utilization rate of the timeline.

In this embodiment, the operation trajectory for each event identifier on the timeline may be obtained, and the video clip corresponding to the event identifier targeted by the operation trajectory may be played in the image playback area of the information display page based on the operation trajectory. As shown in FIG. 28, users open the surveillance system (video playback) and enter the timeline page (information display page). The timeline 610 may display video event bars (event identifiers 621 and 622, etc.) in different colors. Users may clearly see the distribution of all video events (target events). Users may swipe the timeline to the interested event bar (event identifier) to trigger the operation trajectory for each event identifier on the timeline. The system may automatically switch to and play the video clip corresponding to the event identifier targeted by the operation trajectory based on the operation trajectory. Users may quickly find specific event-type video events based on the color of the event bar (event identifier).

As shown in FIG. 26, in this embodiment, the information display page may include an image playback area 410 and a monitoring record area 420. The image playback area 410 may be configured to play real-time images captured by the camera device and video clips corresponding to target events. The monitoring record area 420 may be configured to record relevant monitoring information from at least one of the camera device and an associated device. The monitoring record area 420 may display a timeline 421. The terminal may respond to a triggering operation on a selected event identifier by playing the video clip corresponding to the selected event identifier in the image playback area 410. When a security device (associated device) triggers an alarm (target event), it may activate a camera (target device) to record video (in response to it is a pan-tilt-zoom (PTZ) camera, it may also activate the camera to turn to the alarm location) and mark different events with the color of the video tag (for example, alarm event recording—red, abnormal event recording-orange, normal arming/disarming event recording—yellow, etc.). Various security events may be automatically associated with the camera for recording through associated event tags, and different event types may be marked with different tag colors.

As shown in FIG. 27, in this embodiment, historical events of the home and processing of events/viewing of processing results may be viewed in the monitoring record area 520. The timeline 521, event label information 523 at the corresponding time nodes, and event thumbnails may be displayed in the monitoring record area 520. Events monitored by all smart devices under the whole house may be obtained and displayed on the timeline 521 in the monitoring record area 520 of this information display page. In response to the camera corresponding to the occurred event captures the corresponding event video, the event video corresponding to the event image may also be displayed in the image playback area 510.

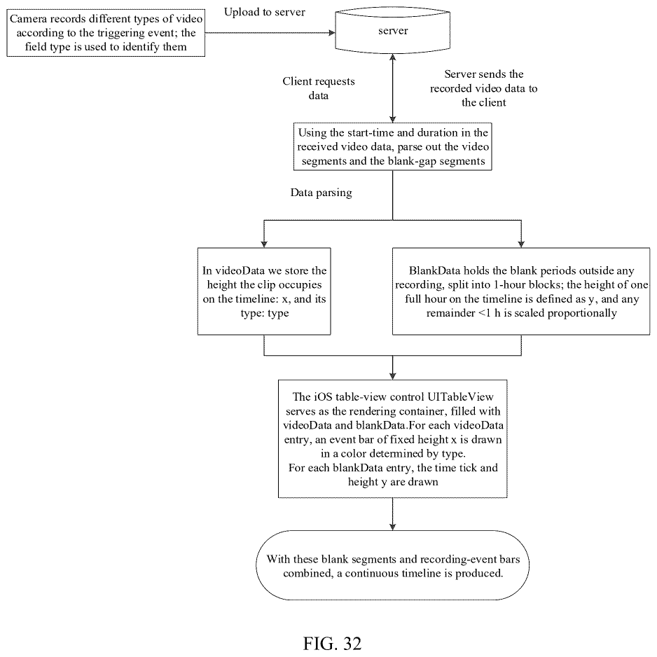

FIG. 32 illustrates a flowchart for drawing a timeline. It includes the following steps:

### Data Acquisition and Parsing

### Video Segment Data (videoData)

Cameras record different types of videos based on different triggering mechanisms (e.g., detecting a person, detecting a pet). The recorded videos log the timestamp when recording starts (startTimeinterval), the duration of the recording (duration), and the type of the recording (type). These data are uploaded to the server after the camera finishes recording and are stored there.

The terminal may request data from the server, with request parameters including the start timestamp (startTimeinterval) and the end timestamp (endTimeinterval), indicating that the terminal wants to obtain all video information data from startTimeinterval to endTimeinterval.

The server may provide all video information for this time period to the terminal.

The terminal receives the video information, and each piece of information contains key data such as startTimeinterval, duration, and type. The startTimeinterval and duration may be configured to determine the specific time point position of the video segment on the timeline, while the type may be configured to distinguish the type of video event. Different types may result in different colors for the drawn event bars. To this end, a video data object (videoDataModel) may be created to record the above data and store it in an NSArray container. NSArray is a widely used data structure in iOS and macOS applications, part of Apple's Foundation framework, configured to store ordered collections of objects.

### Blank Segment Data (blankRangeData)

The range of the entire timeline is from startTimeinterval to endTimeinterval in the request parameters. Since the previous step has already obtained all video data within this time period and knows their time points and durations, the remaining segments on the timeline, excluding these segments, are the blank segments without video.

As shown in FIG. 31, the interval between two video data segments is a blank segment. In cases where the interval between two video data segments is too large, the interval time may be evenly divided into 1-hour segments, with any remainder less than 1 hour recorded as a remainder. This allows recording the time period of each blank segment and creating a blank segment data object (blankRangeDataModel) to store it in an NSArray container.

At this point, the entire timeline is divided into multiple video data segments and blank data segments, each with corresponding data objects.

### Timeline Rendering

The iOS table view control UITableView may be used as the rendering carrier. UITableView is a user interface component in iOS development that provides a way to manage and display scrolling lists, suitable for displaying large amounts of data. Its main features are its efficiency and flexibility, allowing it to handle large amounts of data without affecting performance.

The above data is configured to drive the rendering in chronological order.

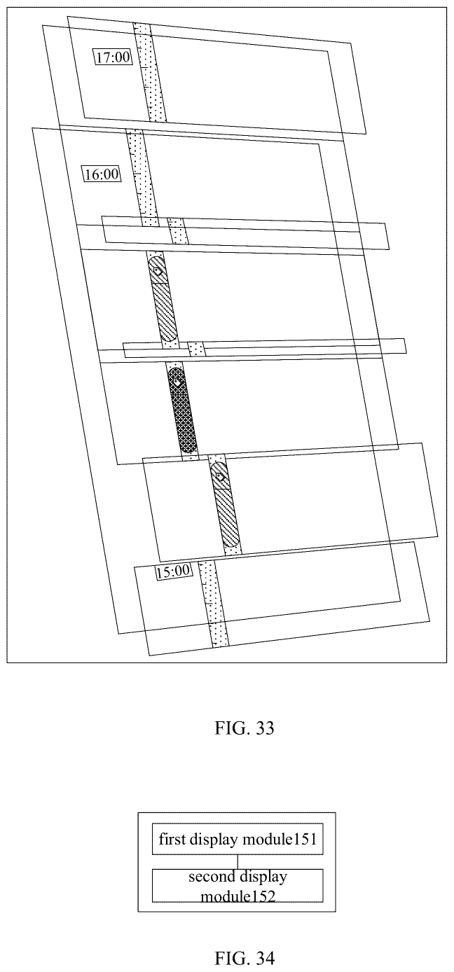

As shown in FIG. 33, when it is a video data segment, an event bar of a certain height (x) is first drawn. Depending on the type, different colors are assigned to the event bar. For example, in response to the video is of human shape recognition type, the event bar is drawn in red. When it is a blank segment data, in response to the duration is 1 hour, a timeline segment of a certain height (y) is drawn, with scales and time text marked at the hour points. For durations less than 1 hour, the height is drawn proportionally.

The solution of this embodiment allows for equal-length event bars on the timeline for video events of different durations. Regardless of the length of the event video, it may be effectively displayed on the timeline. It avoids the issue of short event videos being inconspicuous on the timeline and prevents long event videos from being overly redundant in their display. The blank segments without events on the timeline may use a larger time proportion, allowing a large blank period to be represented by a very small timeline length. This enables more event videos to be displayed on a limited screen page size. The solution of this embodiment may also use multiple colors to distinguish video events on the event bars, allowing users to quickly and accurately locate the video segments they are interested in.

For the timeline drawing process, the solution of this embodiment may first obtain video information generated by the camera from the server or the camera itself (the information includes the start and end times of the video, as well as the type of the video). Then, the current time may be used as the starting point, and the system may look back one hour at a time. In response to there is a video recording that ends within this time period, the start time and the end time of the video are used as a blank data segment. In response to there is no video recording within the past hour, the start time and the time point one hour earlier are used as a blank data segment. The end time point of the timeline may be determined according to business needs, and by iterating through this rule, both blank data and video data may be stored in a container. A 1-hour blank data segment may be set to occupy x screen pixels (the pixels occupied by less than 1 hour of blank data may be calculated here), and video data may occupy y screen pixels. Thus, the timeline may be drawn using data objects, achieving a non-fixed proportion between video event segments and blank time periods. Blank time periods are compressed using a larger time proportion, while video event segments are represented by fixed-length event bars.

The solution of this embodiment makes the timeline display more intuitive and concise on the user interface. Users may clearly see the distribution and types of different video events and may quickly distinguish important events from ordinary ones using colors. The compression of blank time periods on the timeline avoids unnecessary scrolling operations by users through large blank segments without events, enhancing user experience and operational efficiency.

Therefore, the solution of this embodiment makes it more efficient and convenient for users to view and manage camera recordings.

### Exemplary Device

In one embodiment, as shown in FIG. 34, an image display device is provided, the device includes:
a first display module 151, configured to display an event entry area, wherein the event entry area includes event thumbnails corresponding to each event, the event thumbnails are generated based on images related to each event identified from the collected image data;
a second display module 152, configured to in response to a viewing operation on a selected target event thumbnail, displaying an image display page, and displaying the target event view corresponding to the event of the target event thumbnail on the image display page.

In one embodiment, in response to having multiple event thumbnails, the first display module 151 dynamically displays each event thumbnail in the event entry area.

In one embodiment, the second display module 152 is also configured to display a dynamic album page in response to a triggering operation on the event entry area. The dynamic album page includes event thumbnails corresponding to each of the generated events.

In one embodiment, the second display module 152 is also configured to display an album page corresponding to the camera device in response to a triggering operation on the event entry area. The album page includes at least a dynamic album entry. The second display module 152 is also configured to display the dynamic album page in response to a triggering operation on the dynamic album entry. The dynamic album page includes event thumbnails corresponding to each of the generated events.

In one embodiment, when the second display module 152 displays the target event view corresponding to the event of the target event thumbnail on the image display page, it specifically displays at least one of an enlarged image and a video clip corresponding to the target event thumbnail.

In one embodiment, the first display module 151 is also configured to perform at least one of the following: displaying event label information corresponding to each event thumbnail while displaying the event entry area; displaying event label information corresponding to the target event view while displaying the target event view on the image display page. The event label information includes at least one of spatial information, temporal information, and event information.

In one embodiment, the device further includes:
a third display module, configured to display an event configuration page in response to a configuration operation triggered on the event entry area. The event configuration page includes selection controls corresponding to multiple event types;
a binding module, configured to obtain the selected event type and bind the selected event type to the event entry area in response to a triggering operation on the selection controls corresponding to each event type. The bound event type is used for event recognition of the image data captured by the camera device to obtain event images corresponding to each event.

Specific limitations regarding the image display device may refer to the limitations described above for the image display method, and will not be repeated here. The various modules of the above image display device may be implemented in whole or in part through software, hardware, and their combinations. The above modules may be embedded in or independent of the processor of a computer device in hardware form, or may be stored in the memory of a computer device in software form for the processor to call and execute the operations corresponding to each module.

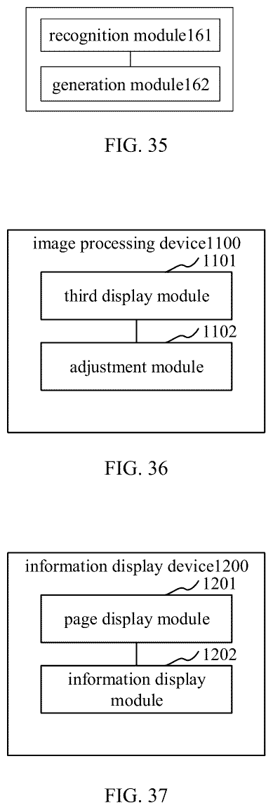

Additionally, in one embodiment, as shown in FIG. 35, an image data processing device is provided, the device includes:
a recognition module 161, configured to recognize events in the collected image data to obtain event images corresponding to each event.
a generation module 162, configured to extract images corresponding to each event from the event images corresponding to each event, and generate event thumbnails corresponding to each event based on the images; the event thumbnails are used for indexing and display in the event entry area, and for displaying the target event view corresponding to the event of the event thumbnail in response to a viewing operation on the event thumbnail in the event entry area.

In one embodiment, when the recognition module 161 recognizes events in the collected image data to obtain event images corresponding to each event, it specifically obtains image data and sequentially performs event recognition on multiple frames of the image data. Based on the recognition results, video clips corresponding to each event are extracted and used as the event images corresponding to each event. Alternatively, it obtains image data and sequentially performs event recognition on multiple frames of the image data. Based on the recognition results, video clips corresponding to each event in the image data are marked to obtain video clips corresponding to each event, which are used as the event images corresponding to each event.

In an exemplary embodiment, as shown in FIG. 36, an image processing device is provided, the device 1100 may include:
a third display module 1101, configured to display an image display area on the display interface of the user terminal, the image display area is configured to display images from the capture device;
an adjustment module 1102, configured to in response to an adjustment operation on the image display area, in response to the area ratio of the image display area meets the adjustment condition, adjusting the area ratio while keeping the display ratio of the image unchanged; the area ratio is configured to indicate the proportion of the image display area in the display interface; the display ratio of the image is configured to indicate the display ratio of the image itself.

In an exemplary embodiment, the adjustment module 1102 is also configured to obtain the current area ratio of the image display area in response to the adjustment operation on the image display area. In response to the current area ratio is the original area ratio and is not the same as the target area ratio, or in response to the current area ratio is an adjusted area ratio, the adjustment module 1102 determines that the current area ratio meets the adjustment condition.

In an exemplary embodiment, the adjustment module 1102 is also configured to determine that the current area ratio does not meet the adjustment condition in response to the current area ratio is the original area ratio and is the same as the target area ratio.

In an exemplary embodiment, the adjustment operation includes a first adjustment operation, which is configured to reduce the area ratio. The adjustment module 1102 is configured to reduce the current area ratio to the target area ratio in response to the first adjustment operation in response to the current area ratio is greater than the target area ratio. Alternatively, the adjustment operation includes a second adjustment operation, which is configured to increase the area ratio. The adjustment module 1102 is configured to increase the current area ratio to the original area ratio in response to the second adjustment operation in response to the current area ratio is the target area ratio.

In an exemplary embodiment, the adjustment module 1102 is also configured to restore the area ratio of the image display area to the original area ratio or to the target area ratio in response to a first return operation or a second return operation on the image display area. The first return operation is the inverse operation of the first adjustment operation, and the second return operation is the inverse operation of the second adjustment operation.

In an exemplary embodiment, the adjustment module 1102 is also configured to perform background filling for the non-image area of the image display area whose area ratio is the target area ratio. The non-image area is the area within the image display area that is outside of the image.

In an exemplary embodiment, the display interface also displays a functional area. The adjustment module 1102 is also configured to adjust the functional area ratio of the functional area based on the change in the area ratio of the image display area. The functional area ratio indicates the proportion of the functional area in the display interface. The sum of the area ratio of the image display area and the functional area ratio remains constant.

In an exemplary embodiment, the functional area includes function implementation buttons. The third display module 1101 is also configured to display function operation information corresponding to the function implementation button in at least one of the image display area and the functional area in response to a selection operation on the function implementation button.

In one embodiment, when the generation module 162 extracts images corresponding to each event from the event images corresponding to each event and generates event thumbnails based on the images, it specifically extracts all frames of images included in the video clip corresponding to the current event and analyzes each frame of images corresponding to the current event to obtain multiple frames of images that meet the extraction conditions. The extraction conditions include at least one of the following: the clarity of the event subject is greater than the preset clarity, and the proportion of the event subject is greater than the preset proportion. One frame of image is selected from the multiple frames of images that meet the extraction conditions as the event thumbnail for the current event.

In one embodiment, the generation module 162 is also configured to combine at least a portion of the event thumbnails corresponding to each event to generate an event snapshot collection. The event snapshot collection is used for dynamic sequential display in the event entry area and for displaying the target event view corresponding to the event of the currently displayed event thumbnail in the event entry area in response to a viewing operation on the currently displayed event thumbnail.

In an exemplary embodiment, as shown in FIG. 37, an information display device 1200 is provided, which includes:
a page display module 1201, configured to display an information display page, the information display page includes a timeline corresponding to the monitoring data; the monitoring data includes surveillance data obtained by at least one of the camera device and the associated device; the associated device is a device associated with the camera device;
an information display module 1202, configured to in response to the existence of a target event, displaying the event information corresponding to the target event on the timeline in the target style according to at least one of the event time and event type of the target event, the target event is identified based on the recognition of the monitoring data.

In an exemplary embodiment, wherein the event information includes an event identifier and event label information; the information display module 1202 is configured to display event identifier corresponding to the target event on the timeline in the target style according to at least one of the event time and event type of the target event, and display the event label information corresponding to the target event based on the display position of the event identifier, and displaying at least one of a thumbnail of a video clip corresponding to the target event and a display entry for the video clip.

In an exemplary embodiment, the information display module 1202 is also configured to display at least one of the event details and the video clip corresponding to the target event in response to a triggering operation on the event label information.

In an exemplary embodiment, the information display module 1202 is also configured to display at least one of the event start time and event end time corresponding to the target event based on the display position of the event identifier.

In an exemplary embodiment, the number of camera devices includes multiple devices. The information display module 1202 is configured to display the event identifier and event label information corresponding to the target event of each camera device on the timeline in the target style according to at least one of the event time and event type of each camera device.

In an exemplary embodiment, the information display module 1202 is also configured to control the camera device associated with the associated device to monitor the occurrence location of the target event to obtain the monitoring data in response to the associated device detecting the target event.

In an exemplary embodiment, the information display page includes an image playback area and a monitoring record area. The image playback area is configured to play real-time images captured by the camera device and video clips corresponding to target events. The information display module 1202 is configured to display the event identifier and event label information corresponding to the target event on the timeline in the monitoring record area in the target style according to at least one of the event time and event type of the target event in response to the existence of a target event. The information display module 1202 is also configured to play the video clip corresponding to the selected event identifier in the image playback area in response to a triggering operation on a selected event identifier.

In an exemplary embodiment, the information display page includes an image playback area and a monitoring record area. The image playback area includes multiple sub-image playback areas corresponding to multiple camera devices. Each sub-image playback area is configured to play real-time images captured by the respective camera devices and video clips corresponding to target events monitored by the respective camera devices. The information display module 1202 is configured to display the event identifier and event label information corresponding to the target event on the timeline in the monitoring record area in the target style according to at least one of the event time and event type of the target event in response to the existence of a target event. The information display module 1202 is also configured to play the video clip corresponding to the selected event identifier in the sub-image playback area corresponding to the camera device that detected the target event in response to a triggering operation on a selected event identifier.

In an exemplary embodiment, the information display module 1202 is also configured to play the video clips corresponding to the event identifiers on the timeline in the order of event time after playing the video clip corresponding to the selected event identifier in the image playback area.

In an exemplary embodiment, the information display module 1202 is also configured to obtain the operation trajectory for each event identifier on the timeline and play the video clip corresponding to the event identifier targeted by the operation trajectory in the image playback area based on the operation trajectory.

In an exemplary embodiment, the target style includes the target size of the event identifier, where the target size of different event identifiers is the same. The target style also includes the target color of the event identifier, where the target color of event identifiers corresponding to different event types is different.

In an exemplary embodiment, the timeline also includes timeline segments where no target events exist. The duration ratio corresponding to the segment size of the timeline segment is greater than the duration ratio corresponding to the target size. The segment size is the size of the timeline segment on the timeline.

In an exemplary embodiment, the page display module 1201 is configured to obtain the duration corresponding to the timeline segment to be displayed. In response to the duration is a unit duration, the segment size of the timeline segment is obtained as the unit segment size corresponding to the unit duration. The unit duration and the unit segment size indicate a duration ratio. In response to the duration does not reach the unit duration, the segment size of the timeline segment is obtained based on the duration ratio and the unit segment size. The timeline containing the timeline segment is displayed on the information display page according to the segment size.

In an exemplary embodiment, the information display module 1202 is also configured to display the timeline segments where no target events exist on the timeline in a preset style. The preset style includes at least one of compressing the timeline segments where no target events exist into a preset-size blank timeline segment and displaying the timeline segments where no target events exist as a preset-shape indicator.

Specific limitations regarding the device may refer to the limitations described above for the method, and will not be repeated here. The various modules of the above device may be implemented in whole or in part through software, hardware, and their combinations. The above modules may be embedded in or independent of the processor of a computer device in hardware form, or may be stored in the memory of a computer device in software form for the processor to call and execute the operations corresponding to each module.

### Exemplary Electronic Device

In one embodiment, an electronic device is provided, which includes at least one processor and at least one memory. The memory stores computer-readable instructions. When the computer-readable instructions are executed by the processor, the processor is caused to implement the steps described in the above method embodiments.

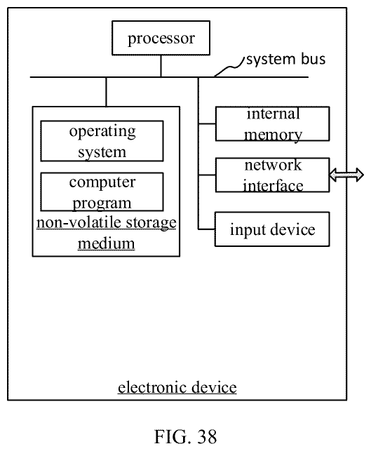

Another embodiment of this disclosure proposes an electronic device, the internal structure of which may be shown in FIG. 38. The electronic device includes a processor, memory, network interface, and input device connected through a system bus. The processor of the electronic device is configured to provide computing and control capabilities. The memory of the electronic device includes non-volatile storage media and internal memory. The non-volatile storage media stores an operating system and computer programs. The internal memory provides an environment for the operation of the operating system and computer programs in the non-volatile storage media. The network interface of the electronic device is configured to communicate with external terminals through a network connection. When the computer program is executed by the processor, it implements the steps described in the above method embodiments.

The processor may include a main processor, as well as a baseband chip, modem, etc.

The memory stores computer programs for implementing the technical solutions of this disclosure, and may also store an operating system and other key services. Specifically, the computer program may include program code, which includes computer operation instructions. More specifically, the memory may include read-only memory (ROM), other types of static storage devices that may store static information and instructions, random access memory (RAM), other types of dynamic storage devices that may store information and instructions, disk storage, flash, etc.

The processor may be a general-purpose processor, such as a general central processing unit (CPU), microprocessor, etc., or it may be an application-specific integrated circuit (ASIC), or one or more integrated circuits configured to control the execution of the programs of this disclosure. It may also be a digital signal processor (DSP), application-specific integrated circuit (ASIC), field-programmable gate array (FPGA), or other programmable logic devices, discrete gate or transistor logic devices, discrete hardware components.

The input device may include devices for receiving data and information input by users, such as keyboards, mice, cameras, scanners, light pens, voice input devices, touch screens, pedometers, or accelerometers, etc.

The output device may include devices that allow outputting information to users, such as displays, printers, speakers, etc.

The communication interface may include any transceiver-like device to communicate with other devices or communication networks, such as Ethernet, wireless access networks (RAN), wireless local area networks (WLAN), etc.

The processor executes the computer programs stored in the memory and calls other devices to implement the steps described in the above method embodiments.

The electronic device may also include a display component and a voice component. The display component may be a liquid crystal display or an electronic ink display. The input device of the electronic device may be a touch layer covering the display component, or it may be buttons, trackballs, or touchpads set on the housing of the electronic device, or it may be an external keyboard, touchpad, or mouse, etc.

Those skilled in the art may understand that the structure shown in FIG. 38 is merely a block diagram of the parts related to the solution of this disclosure and does not constitute a limitation on the electronic device to which the solution of this disclosure is applied. The specific electronic device may include more or fewer components than shown in the FIG., or combine certain components, or have a different component layout.

### Exemplary Computer Program Product and Computer-Readable Storage Medium

In one embodiment, a computer program product or computer program is provided. The computer program product or computer program includes computer-readable instructions, which are stored in a computer-readable storage medium. The processor of a computer device reads the computer-readable instructions from the computer-readable storage medium. When the processor executes the computer-readable instructions, it implements the steps of the image display method or image data processing method described in the various embodiments of this disclosure.

The computer program product may be written in program code for performing the operations of the embodiments of this disclosure using a combination of one or more programming languages. The programming languages include object-oriented programming languages, such as Java, C++, and also include conventional procedural programming languages, such as the “C” language or similar programming languages. The program code may be executed entirely on a device or as a standalone software package.

In one embodiment, a computer-readable storage medium is provided, which stores computer-readable instructions. When executed by one or more processors, the computer-readable instructions implement the steps of the image display method or image data processing method shown in the exemplary method section of the above embodiments.

Ordinary technical personnel in this field may understand that the entire or part of the process of implementing the above embodiment methods may be completed by instructing relevant hardware through computer-readable instructions. The computer-readable instructions may be stored in a non-volatile computer-readable storage medium. When executed, the computer-readable instructions may include the processes of the above method embodiments. The references to memory, storage, databases, or other media used in the various embodiments of this disclosure may include at least one of non-volatile and volatile memory. Non-volatile memory may include read-only memory (ROM), programmable ROM (PROM), electrically programmable ROM (EPROM), electrically erasable programmable ROM (EEPROM), or flash memory. Volatile memory may include random access memory (RAM) or external high-speed buffer memory. As an illustration rather than a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM), etc.

The technical features of the above embodiments may be combined in any way. In order to make the description concise, not all possible combinations of the technical features in the above embodiments have been described. However, as long as the combination of these technical features does not conflict, it should be considered within the scope of this specification.

The above-described embodiments only express several implementation methods of this disclosure. Their description is relatively specific and detailed, but it should not be understood as a limitation on the scope of the invention patent. It should be pointed out that for ordinary technical personnel in this field, under the premise of not departing from the concept of this disclosure, several deformations and improvements may still be made, and these all belong to the scope of protection of this disclosure. Therefore, the scope of protection of this invention patent should be based on the appended claims.

What is claimed is:

1. An image display method, performed by a user terminal, the method comprising:
displaying an event entry area, wherein the event entry area includes event thumbnails corresponding to each event; the event thumbnails are generated based on images related to each event identified from the collected image data;
in response to a viewing operation on a selected target event thumbnail, displaying an image display page, and displaying the target event view corresponding to the event of the target event thumbnail on the image display page.

2. The method of claim 1, wherein in response to the existence of multiple event thumbnails, each of the event thumbnails is dynamically displayed in the event entry area if there are multiple event thumbnails, the event thumbnails are displayed dynamically within the event entry area.

3. The method of claim 1, wherein the method further comprising:
in response to a triggering operation on the event entry area, displaying a dynamic album page; the dynamic album page includes event thumbnails corresponding to each of the generated events.

4. The method of claim 1, wherein the event entry area is an entry for indicating the event images captured by the camera device; the method further comprising:
in response to a triggering operation on the event entry area, displaying an album page corresponding to the camera device; the album page includes at least a dynamic album entry;
in response to a triggering operation on the dynamic album entry, displaying a dynamic album page; the dynamic album page includes event thumbnails corresponding to each of the generated events.

5. The method of claim 1, wherein displaying the target event view corresponding to the event of the target event thumbnail on the image display page comprising:
displaying at least one of an enlarged image and a video clip corresponding to the target event thumbnail on the image display page.

6. The method of claim 1, wherein the method further comprising at least one of the following:
while displaying the event entry area, displaying event information corresponding to each of the event thumbnails;
while displaying the target event view on the image display page, displaying event information corresponding to the target event image;
wherein the event information includes at least one of spatial information, temporal information, and event label information.

7. The method of claim 1, wherein prior to displaying the event entry area, the method further comprising:
in response to a configuration operation triggered on the event entry area, displaying an event configuration page; the event configuration page includes selection controls corresponding to multiple event types;
in response to a triggering operation on the selection controls corresponding to each of the event types, obtaining the selected event type and binding the selected event type to the event entry area; the bound event type is used for recognizing the image data captured by the camera device to obtain the event images corresponding to each event.

8. The method of claim 1, wherein the image display page includes an image display area, the method further comprising:
displaying the image display area on the display interface of the user terminal, the image display area being configured to display at least one of the images captured by the camera device and the target event view corresponding to the event of the target event thumbnail;
in response to an adjustment operation on the image display area, if the area ratio of the image display area meets the adjustment condition, adjusting the area ratio while keeping the display ratio of the image unchanged; the area ratio is configured to indicate the proportion of the image display area in the display interface; the display ratio of the image is configured to indicate the display ratio of the image itself.

9. The method of claim 8, wherein prior to in response to the area ratio of the image display area meets the adjustment condition, adjusting the area ratio while keeping the display ratio of the image unchanged, the method further comprising:
in response to an adjustment operation on the image display area, obtaining the current area ratio of the image display area;
in response to the current area ratio being the original area ratio and different from the target area ratio, or in response to the current area ratio is an adjusted area ratio, determining that the current area ratio meets the adjustment condition.

10. The method of claim 8, wherein the display interface also displays a functional area, the method further comprising:
adjusting the functional area ratio of the functional area in response to the change in the area ratio of the image display area; the functional area ratio is configured to indicate the proportion of the functional area in the display interface; the sum of the area ratio of the image display area and the functional area ratio remains unchanged.

11. The method of claim 1, wherein the method comprising:
displaying an information display page; the information display page includes an event timeline corresponding to the monitoring data; the monitoring data includes surveillance data obtained by at least one of the camera device and the associated device; the associated device is a device associated with the camera device;
in response to the existence of a target event, displaying the event information corresponding to the target event on the timeline in the target style according to at least one of the event time and event type of the target event.

12. The method of claim 11, wherein the event information includes an event identifier and event label information;
wherein displaying the event information corresponding to the target event on the timeline in the target style according to at least one of the event time and event type of the target event comprising:
displaying the event identifier corresponding to the target event on the timeline in the target style according to at least one of the event time and event type of the target event;
displaying the event label information corresponding to the target event based on the display position of the event identifier, and displaying at least one of a thumbnail of a video clip corresponding to the target event and a display entry for the video clip.

13. The method of claim 11, wherein the information display page includes an image playback area and a monitoring record area; the image playback area is configured to play real-time images captured by the target device and video clips corresponding to target events;
wherein in response to the existence of a target event, displaying the event identifier and event information corresponding to the target event on the timeline in the target style according to at least one of the event time and event type of the target event comprising:
in response to the existence of a target event, displaying the event identifier and event information corresponding to the target event on the timeline in the target style in the monitoring record area according to at least one of the event time and event type of the target event;
the method further comprising:
in response to a triggering operation on a selected event identifier, playing the video clip corresponding to the selected event identifier in the image playback area.

14. The method of claim 11, wherein the information display page includes an image playback area and a monitoring record area; the image playback area includes multiple sub-image playback areas corresponding to multiple target devices; each of the sub-image playback areas is configured to play real-time images captured by the respective target device and video clips corresponding to target events monitored by the respective target device;
wherein in response to the existence of a target event, displaying the event identifier and event information corresponding to the target event on the timeline in the target style according to at least one of the event time and event type of the target event comprising:
in response to the existence of a target event, displaying the event identifier and event information corresponding to the target event on the timeline in the target style in the monitoring record area according to at least one of the event time and event type of the target event;
the method further comprising:
in response to a triggering operation on a selected event identifier, playing the video clip corresponding to the selected event identifier in the sub-image playback area corresponding to the target device where the target event was detected.

15. The method of claim 11, wherein the target style includes the target size of the event identifier, and the target size of different event identifiers is the same; the target style also includes the target color of the event identifier, and the target color of event identifiers corresponding to different event types is different; the timeline also includes timeline segments where no target events exist; the segment size of the timeline segment corresponds to a duration ratio that is greater than the duration ratio corresponding to the target size; the segment size is the size of the timeline segment on the timeline.

16. An image data processing method, performed by an electronic device, the method comprising:
recognizing events in the collected image data to obtain event images corresponding to each event;
extracting images corresponding to each of the events from the event images corresponding to each event, and generating event thumbnails corresponding to each of the events based on the images; the event thumbnails are used for indexing and display in the event entry area, and for displaying the target event view corresponding to the event of the event thumbnail in response to a viewing operation on the event thumbnail in the event entry area.

17. The method of claim 16, wherein recognizing events in the collected image data to obtain event images corresponding to each event comprising:
obtaining image data and sequentially performing event recognition on multiple frames of the image data, extracting video clips corresponding to each event based on the recognition results, and using these video clips as the event images corresponding to each event;
or, obtaining image data and sequentially performing event recognition on multiple frames of the image data, marking video clips corresponding to each event in the image data based on the recognition results, and using these marked video clips as the event images corresponding to each event.

18. The method of claim 17, wherein extracting images corresponding to each of the events from the event images corresponding to each event, and generating event thumbnails corresponding to each of the events based on the images comprising:
extracting all frames of images included in the video clip corresponding to the current event, and analyzing each frame of images corresponding to the current event to obtain multiple frames of images that meet the extraction conditions; wherein the extraction conditions include at least one of the following: the clarity of the event subject is greater than the preset clarity, and the proportion of the event subject is greater than the preset proportion;
selecting one frame of image from the multiple frames of images that meet the extraction conditions as the event thumbnail for the current event.

19. The method of claim 16, wherein the method further comprising:
combining at least a portion of the event thumbnails corresponding to each of the events to generate an event snapshot collection; the event snapshot collection is used for dynamic sequential display in the event entry area, and for displaying the target event view corresponding to the event of the currently displayed event thumbnail in the event entry area in response to a viewing operation on the currently displayed event thumbnail.

20. An electronic device, comprising:
at least one processor; and
at least one memory storing computer-executable instructions that, when executed by the at least one processor, cause the electronic device to perform the steps of the method according to claim 1.
